(19) United States
(12) Patent Application Publication
(10) Pub. No.: US 2004/0007331 A1
(43) Pub. Date: Jan. 15, 2004

(54) Mark transfer tool and mark transfer tape

(76) Inventors: Shigeru Tamai, Osaka (JP); Masatoshi Shintani, Sanda-shi (JP); Mikio Toyoda, Kawagoe-shi (JP); Nobuyuki Motoyama, Fukaya-shi (JP); Yoshiyuki Hori, Hillsboro, OR (US); Goro Inoue, Fukaya-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/608,198

(22) Filed: Jun. 30, 2003

(30) Foreign Application Priority Data
Jul. 10, 2002 (JP) 2002-201993

(51) Int. Cl. B32B 9/00

(52) U.S. Cl. 156/577; 428/40.1

(57) ABSTRACT

A mark transfer tool making use of coat film transfer technology, in various marks composed of characters, signs, symbols, or combination thereof. A mark transfer tape of a mark transfer tool has a transfer mark layer peelably adhered and held on a base tape. The transfer mark layer is formed by integrally laminating a pressure-sensitive adhesive layer, a mark array layer, and a surface forming layer, in which the adhesive force PA of the pressure-sensitive adhesive layer on the transfer area, the rupture strength PB of the transfer mark layer, the adhesive force PC of the transfer mark layer and base tape, and the adhesive force PD of the pressure-sensitive adhesive layer and base tape are set in the relation of PA≧PB≧PC≧PD, and the elongation rate of the transfer mark layer is set in a visual deformation allowable range of the transfer mark at the time of its pressing and transferring. Therefore, the transfer mark is transferred without visual deformation, crack or cut, so that a favorable transfer property is assured.

### BACKGROUND OF THE INVENTION

1. Field of the Invention

The present invention relates to a mark transfer tool and a mark transfer tape, and more particularly to a mark transfer technology for transferring a thin film of a transfer mark such as characters, signs, symbols or combination thereof arranged and formed on a mark transfer tape onto a sheet of paper or the like.

2. Description of the Related Art

Generally, various marks composed of characters, signs, symbols or combination thereof are prepared in a form of a stamp, and is pressed and transferred on the surface of an object such as sheet of paper by means of ink, or prepared in a form of mark seal, and adhered on a sheet of paper.

In the recent technical innovation and diversification of preferences of general users, a wide variety of products is demanded in various technical fields, and this trend is no exception in the stationery field handling various marks.

### BRIEF SUMMARY OF THE INVENTION

It is hence a primary object of the invention to present a novel mark transfer tool and mark transfer tape solving the conventional problems.

It is other object of the invention to present a novel mark transfer technology utterly differently from the conventional mark using technology, about various marks of characters, signs, symbols or combination thereof, by employing a thin film transfer technology.

A mark transfer tool of the invention comprises a hand-held case, a pay-out reel of mark transfer tape rotatably installed in the case, a winding reel for collecting the used mark transfer tape rotatably installed in the case, and a transfer head for pressing and transferring the mark transfer tape paid out from the pay-out reel onto the transfer area, being disposed in the leading end portion of the case, in which the mark transfer tape has a peelable transfer mark layer of multiple pressure-sensitive adhesive transfer marks adhesively held on the surface side of a base tape, and this transfer mark layer is formed by integrally laminating at least a pressure-sensitive adhesive layer of pressure-sensitive adhesive material, and a mark array layer of multiple marks consecutively arranged at specific intervals in the running direction of the base tape, and further the adhesive force PA of the pressure-sensitive adhesive layer on the transfer area, the rupture strength PB of the transfer mark layer, the adhesive force PC of the transfer mark layer and base tape, and the adhesive force PD of the pressure-sensitive adhesive layer and base tape are set in the relation of PA≧PB≧PC≧PD, and the elongation rate of the transfer mark layer is set in a visual deformation allowable range of the transfer mark at the time of pressing and transferring of the transfer mark layer by the transfer head.

In a preferred embodiment, the transfer mark is either composed of various indication marks only, or composed of both various indication marks and overwriting spaces, and in the latter case at least the surface forming portion of the overwriting spaces should be made of a material for writing on by a writing tool.

The basic structure of a mark transfer tool is either a refill type in which a tape cartridge comprising at least the pay-out reel and winding reel is detachably installed in the case so that the mark transfer tape can be exchanged, or a disposable type in which the pay-out reel and winding reel are installed in the case and the transfer head is provided in the leading end portion of the case.

A mark transfer tape of the invention is preferably provided and used in such mark transfer tool, in which a transfer mark layer of multiple pressure-sensitive adhesive transfer marks is peelably adhered and held on the surface side of a base tape, the transfer mark layer is formed by integrally laminating at least a pressure-sensitive adhesive layer of pressure-sensitive adhesive material, and a mark array layer of multiple marks consecutively arranged at specific intervals in the running direction of the base tape, and further the adhesive force PA of the pressure-sensitive adhesive layer on the transfer area, the rupture strength PB of the transfer mark layer, the adhesive force PC of the transfer mark layer and base tape, and the adhesive force PD of the pressure-sensitive adhesive layer and base tape are set in the relation of PA≧PB≧PC≧PD, and the elongation rate of the transfer mark layer is set in a visual deformation allowable range of the transfer mark at the time of pressing and transferring of the transfer mark layer by the transfer head.

In a preferred embodiment, rubber-like resin and glass-like resin are contained as constituent materials for determining the elongation rate of the transfer mark layer, and the elongation rate of this transfer mark layer is set at a specified value within the visual deformation allowable range by adjusting the blending rates of the rubber-like and glass-like resins.

The mark transfer tape of the invention is laminated in the following structure.

i) The transfer mark layer is formed by integrally laminating the pressure-sensitive adhesive layer of transparent material and the mark array layer, and this transfer mark layer is peelably and separably adhered and held on a parting treated surface of the base tape by way of the pressure-sensitive adhesive layer.

ii) The transfer mark layer is formed by integrally laminating the mark array layer and pressure-sensitive adhesive layer, and this transfer mark layer is peelably and separably adhered and held on a parting treated surface of the base tape by way of the pressure-sensitive adhesive layer.

iii) The transfer mark layer is formed by integrally laminating the mark array layer and pressure-sensitive adhesive layer, and this transfer mark layer is peelably and separably adhered and held on an adhesive treated surface of the base tape by way of the mark array layer.

Further, the transfer mark layer is formed by integrally laminating a pressure-sensitive adhesive layer of a pressure-sensitive adhesive transparent material, a mark array layer of multiple marks consecutively arranged at specified intervals in the running direction of a base tape, and a surface forming layer forming a surface portion, and the mark array layer has its elongation rate set larger than the elongation rate of the surface forming layer, and its rupture strength set smaller than the rupture strength of the surface forming layer. Preferably, the following laminating structure is employed.

iv) The transfer mark layer is formed by integrally laminating sequentially the surface forming layer of adhesive transparent material, mark array layer, and pressure-sensitive adhesive layer, and this transfer mark layer is peelably and separably adhered and held on a parting treated surface of the base tape by way of the surface forming layer.

v) The transfer mark layer is formed by integrally laminating sequentially the surface forming layer of adhesive transparent material, pressure-sensitive adhesive layer of transparent material, and mark array layer, and this transfer mark layer is peelably and separably adhered and held on a parting treated surface of the base tape by way of the surface forming layer.

vi) The transfer mark layer is formed by integrally laminating sequentially the mark array layer, surface forming layer, and pressure-sensitive adhesive layer, and this transfer mark layer is peelably and separably adhered and held on a parting treated surface of the base tape by way of the mark array layer.

Further, the transfer mark is either composed of various indication marks only, or composed of both various indication marks and overwriting spaces, and in the latter case the surface forming portion of the transfer mark layer should be made of a material for writing on by a writing tool, or the overwriting space of the transfer mark should be preferably prepared as a writing window penetrating through the face and back side of the transfer mark.

In addition, at least two cutting lines are provided at a specified interval between transfer marks of the transfer mark layer, or multiple cutting lines are provided in the transfer mark layer at a specified interval in the overall length of the transfer mark layer. These cutting lines are linearly extended and formed in the overall width of the transfer mark layer, and the forming interval is set larger than the pressing width of the leading end pressing portion of the transfer head for pressing and transferring the transfer head.

Moreover, depending on the purpose, the transfer mark may contain a fragrant component to be presented as an aromatic mark having an aromatic effect, or may contain an antibacterial component to be presented as an antibacterial mark having an antibacterial effect.

By the mark transfer tool of the invention, to transfer a transfer mark of the transfer mark layer adhered and held on the mark transfer tape on a desired transfer area on a sheet of paper or the like, the case is held by hand and fingers, the leading end pressing portion of the transfer head is pressed tightly against the transfer area, and the case is directly moved along the sheet of paper, so that the transfer mark is transferred.

In this case, the adhesive force PA of the pressure-sensitive adhesive layer on the transfer area, the rupture strength PB of the transfer mark layer, the adhesive force PC of the transfer mark layer and base tape, and the adhesive force PD of the pressure-sensitive adhesive layer and base tape are set in the relation of PA≧PB≧PC≧PD, and the elongation rate of the transfer mark layer is set in a visual deformation allowable range of the transfer mark at the time of pressing and transferring of the transfer mark layer by the transfer head, and therefore the transfer mark layer can be cut off favorably at a desired position, that is, a favorable transfer performance of a desired transfer only is assured.

Besides, since the cutting lines are properly provided in the transfer mark layer, together with the favorable transfer performance, the transfer mark layer can be cut off easily at a desired position.

In the case of the transfer mark composed of indication mark and overwriting space, overwriting in the overwriting space by a writing tool is possible after transfer.

These and other related objects and features of the invention will be more clearly understood by reading the detailed description in conjunction with the accompanying drawings and novel facts indicated in the claims thereof.

### BRIEF DESCRIPTION OF THE DRAWING

FIG. 1 is a perspective view showing a mark transfer tool in embodiment 1 of the invention.

FIG. 2 is a front view showing the inside of the case main body of the mark transfer tool.

FIG. 3 is a perspective exploded view of the mark transfer tool.

FIG. 4A is a perspective view showing essential parts of transfer head of the mark transfer tool.

FIG. 4B is a plan view showing essential parts of transfer head of the mark transfer tool.

FIG. 5A shows a mark transfer tape of the mark transfer tool, in a partially cut-away plan view of the mark transfer tape in manufacturing process.

FIG. 5B also shows a mark transfer tape of the mark transfer tool, in a sectional view along line B-B in FIG. 5A of the mark transfer tape.

FIG. 5C also shows a mark transfer tape of the mark transfer tool, in a sectional view of peeling state of base tape and transfer mark layer of the mark transfer tape.

FIG. 6 is a schematic diagram explaining design conditions required in a mark transfer tape of the mark transfer tool.

FIG. 7A to FIG. 7C are magnified front views showing a partial section of rotation structure of transfer head of the mark transfer tool.

FIG. 8A is a perspective view showing a state of use of the mark transfer tool, showing a lateral pulling state by right hand.

FIG. 8B is a perspective view showing a state of use of the mark transfer tool, showing a lateral pulling state by left hand.

FIG. 8C is a perspective view showing a state of use of the mark transfer tool, showing a vertical pulling state by right hand.

FIG. 9A is a partially cut-away plan view of mark transfer tape in manufacturing process, showing the mark transfer tape of mark transfer tool in embodiment 2 of the invention.

FIG. 9B is a sectional view along line B-B in FIG. 9A of the mark transfer tape, showing the mark transfer tape.

FIG. 9C is a sectional view of peeling state of base tape and transfer mark layer of mark transfer tape, showing the mark transfer tape.

FIG. 10A is a partially cut-away plan view of mark transfer tape in manufacturing process, showing the mark transfer tape of mark transfer tool in embodiment 3 of the invention.

FIG. 10B is a sectional view along line B-B in FIG. 10A of the mark transfer tape, showing the mark transfer tape.

FIG. 10C is a sectional view showing the pressing width of leading end pressing portion of transfer head of the mark transfer tool in relation to the mark transfer tape.

FIG. 11A is a partially cut-away plan view of mark transfer tape in manufacturing process, showing the mark transfer tape of mark transfer tool in embodiment 4 of the invention.

FIG. 11B is a sectional view along line B-B in FIG. 11A of the mark transfer tape, showing the mark transfer tape.

FIG. 11C is a sectional view showing the pressing width of leading end pressing portion of transfer head of the mark transfer tool in relation to the mark transfer tape.

FIG. 12A is a partially cut-away plan view of mark transfer tape in manufacturing process, showing the mark transfer tape of mark transfer tool in embodiment 5 of the invention.

FIG. 12B is a magnified plan view of transfer mark of the mark transfer tape.

FIG. 12C is a sectional view along line B-B in FIG. 12A, showing the mark transfer tape.

FIG. 13A is a perspective view showing an overwriting state by a writing tool after mark transfer by the mark transfer tool.

FIG. 13B is a plan view showing a modified example of the transfer mark.

FIG. 13C is a plan view showing other modified example of the transfer mark.

FIG. 14A is a plan view of mark transfer tape of mark transfer tool in embodiment 6 of the invention.

FIG. 14B is a sectional view along line B-B in FIG. 14A of the mark transfer tape.

FIG. 14C is a perspective view showing an overwriting state by a writing tool after mark transfer by the mark transfer tool.

FIG. 15 is a perspective exploded view of mark transfer tool in embodiment 7 of the invention.

FIG. 16A is a partially cut-away plan view of mark transfer tape in manufacturing process, showing the mark transfer tape of mark transfer tool in embodiment 8 of the invention.

FIG. 16B is a sectional view along line B-B in FIG. 16A of the mark transfer tape.

FIG. 16C is a sectional view of peeling state of base tape and transfer mark layer of the mark transfer tape.

FIG. 17A is a partially cut-away plan view of mark transfer tape in manufacturing process, showing the mark transfer tape of mark transfer tool in embodiment 9 of the invention.

FIG. 17B is a sectional view along line B-B in FIG. 17A of the mark transfer tape.

FIG. 17C is a sectional view of peeling state of base tape and transfer mark layer of the mark transfer tape.

FIG. 18A is a partially cut-away plan view of mark transfer tape in manufacturing process, showing the mark transfer tape of mark transfer tool in embodiment 10 of the invention.

FIG. 18B is a sectional view along line B-B in FIG. 18A of the mark transfer tape.

FIG. 18C is a sectional view of peeling state of base tape and transfer mark layer of the mark transfer tape.

FIG. 19A is a partially cut-away plan view of mark transfer tape in manufacturing process, showing the mark transfer tape of mark transfer tool in embodiment 11 of the invention.

FIG. 19B is a sectional view along line B-B in FIG. 19A of the mark transfer tape.

FIG. 19C is a sectional view of peeling state of base tape and transfer mark layer of the mark transfer tape.

FIG. 20A is a partially cut-away plan view of mark transfer tape in manufacturing process, showing the mark transfer tape of mark transfer tool in embodiment 12 of the invention.

FIG. 20B is a sectional view along line B-B in FIG. 20A of the mark transfer tape.

FIG. 20C is a sectional view of peeling state of base tape and transfer mark layer of the mark transfer tape.

FIG. 21A is a perspective view showing essential parts of transfer head of mark transfer tool in embodiment 13 of the invention.

FIG. 21B is a plan view showing essential parts of the transfer head.

FIG. 21C is a side sectional view showing essential parts of the transfer head.

FIG. 22A is a perspective view showing essential parts of transfer head of mark transfer tool in embodiment 14 of the invention.

FIG. 22B is a plan view showing essential parts of the transfer head.

FIG. 22C is a side sectional view showing essential parts of the transfer head.

FIG. 23A is a perspective view showing a lateral pulling use type of transfer head of mark transfer tool in embodiment 15 of the invention.

FIG. 23B is a perspective view showing a vertical pulling use type of the transfer head.

### DETAILED DESCRIPTION OF THE PREFERRED EMBODIMENTS

Preferred embodiments of the invention are specifically described below while referring to the accompanying drawings.

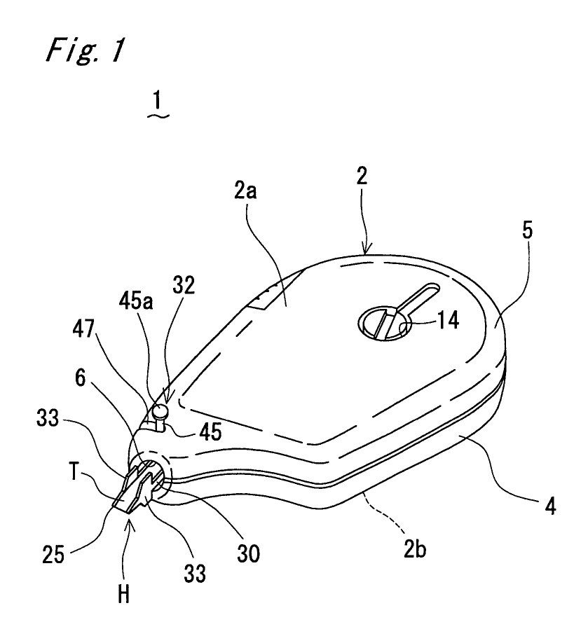

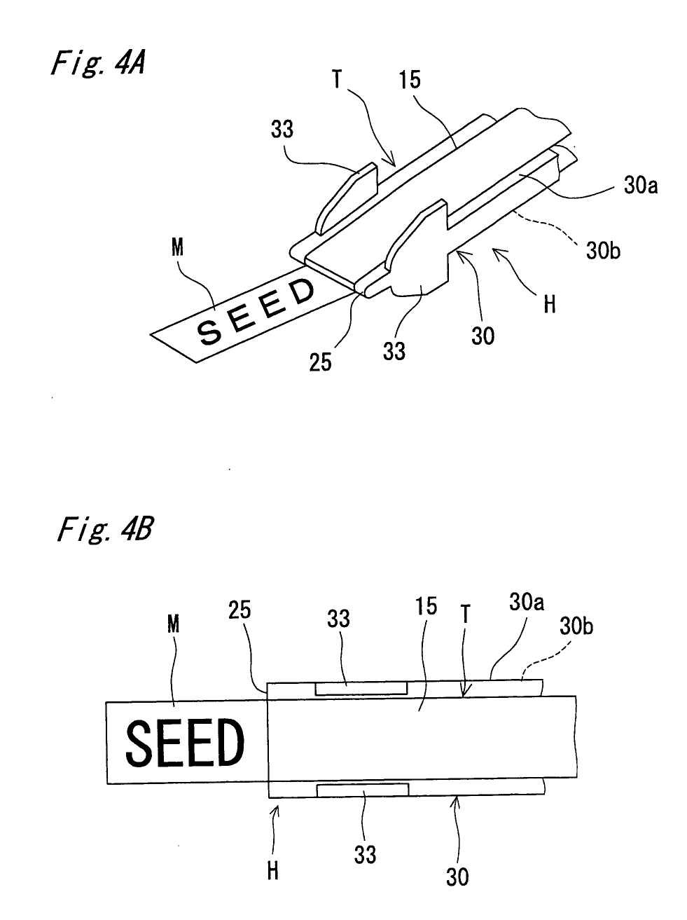

FIG. 1 to FIG. 23 show mark transfer tools of the invention, and same reference numerals throughout the drawings indicate same constituent members or elements.

Embodiment 1

A mark transfer tool of this embodiment is shown in FIG. 1 to FIG. 8. This mark transfer tool 1 is specifically intended to transfer marks M, M, . . . (indication mark of alphabetic letters SEED in this shown example) in a thin film of characters, signs, symbols or combination thereof arrayed and formed on a mark transfer tape T, on a sheet of paper or the like, and it is a refill type of cartridge structure having an exchangeable mark transfer tape T as consumable part.

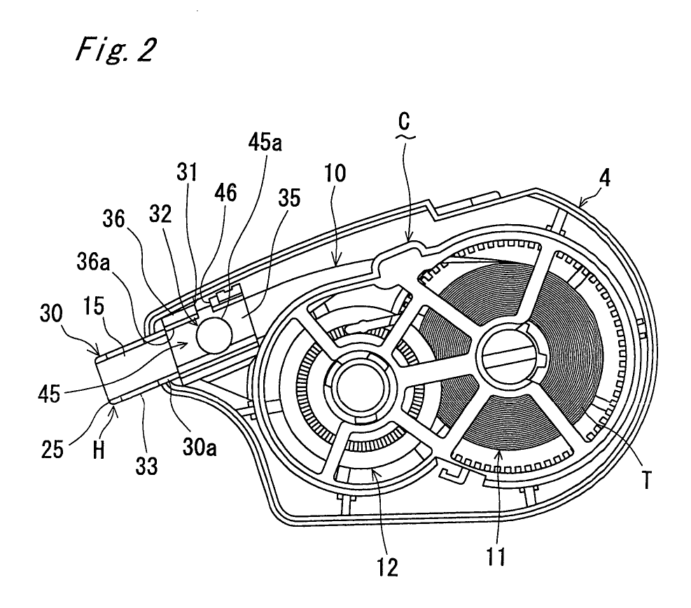

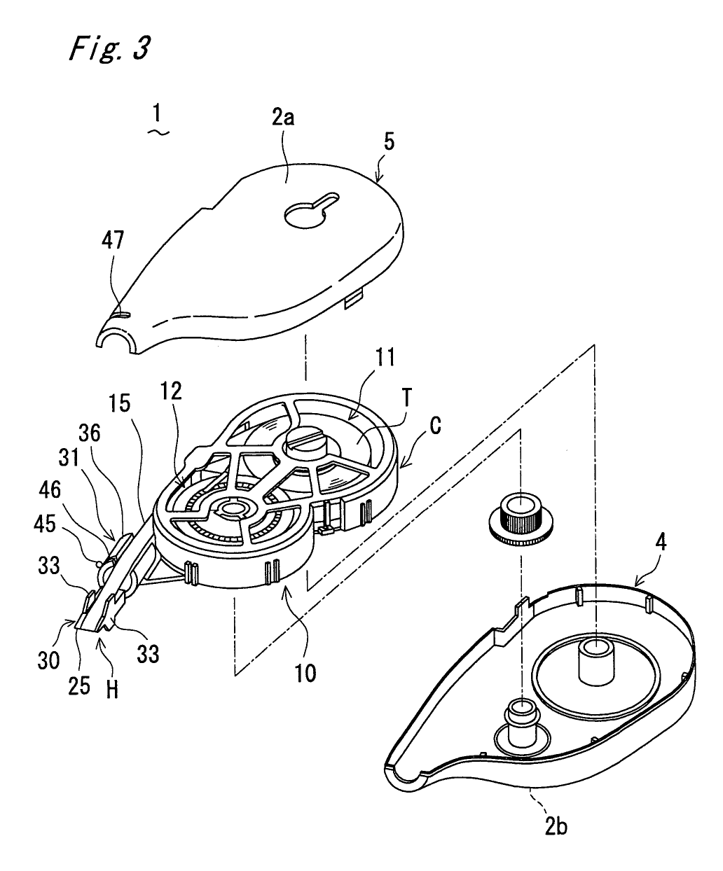

That is, the mark transfer tool 1 comprises a case 2 of which appearance is as shown in FIG. 1, and a tape cartridge C having a transfer head H installed therein as shown in FIG. 2 and FIG. 3.

The case 2 can be held and manipulated by one hand, and it is a flat box having the front contour shape and dimension and width dimension capable of incorporating the tape cartridge C, and its pair of confronting flat face and back sides 2a, 2b are basic gripping surfaces when holding and manipulating. This case 2 is a plastic structure integrally formed by injection molding or the like, and a case main body 4 and a cap body 5 are opened and closed separably, and the tape cartridge C is detachably mounted on the case main body 4. At the leading end of the case 2, a head inserting portion 6 is formed to penetrate inside and outside of the transfer head H.

The tape cartridge C is an exchangeable part as consumable part. The tape cartridge C comprises a pay-out reel 11 having a mark transfer tape T and a rotatably winding reel 12 for collecting the used mark transfer tape T, rotatably installed in the cartridge case 10, and a transfer head H for pressing and transferring the mark transfer tape T is disposed rotatably about its head axial center.

Although not specifically shown in the drawing, the tape cartridge C is a unit structure including principal basic components, such as tape interlocking section for mutually interlocking the pay-out reel 11 and winding reel 12, and clutch mechanism for synchronizing the pay-out speed and winding speed of the mark transfer tape T in the pay-out reel 11 and winding reel 12.

The cartridge case 10 is made of synthetic resin for accommodating both reels 11 and 12, and its shape and dimension are set to be lightweight and compact as far as possible in a range of having a holding function of the both reels 11, 12, and specifically it has a skeleton structure mainly composed of thin skeleton members.

The mark transfer tape T has a transfer mark layer 16 composed of multiple pressure-sensitive adhesive transfer marks M, M, . . . peelably adhered and held on the surface side of a base tape 15.

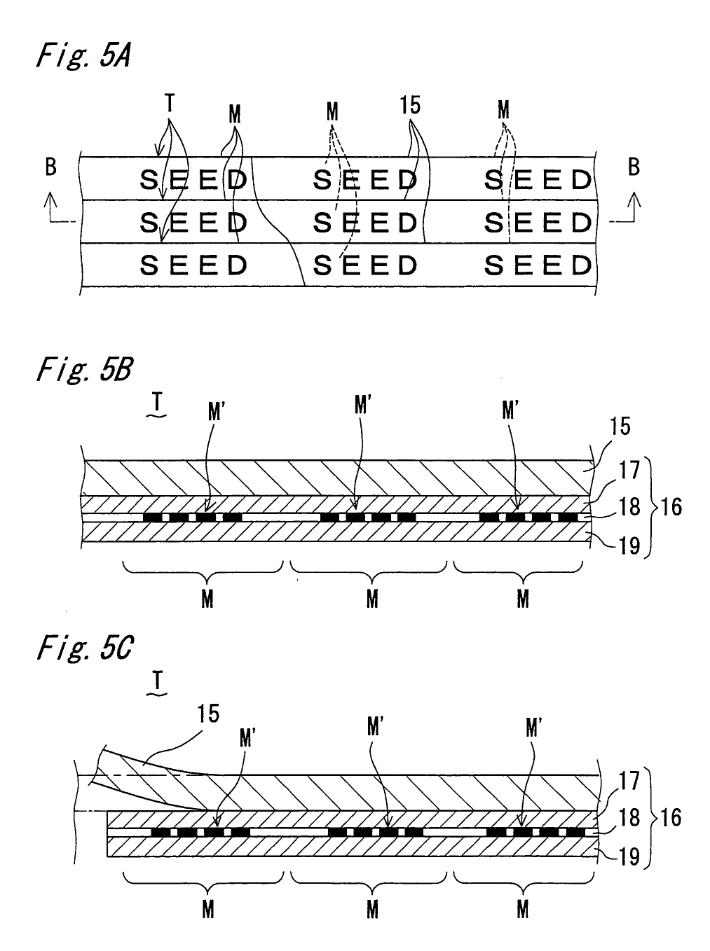

In the shown embodiment, the mark transfer tape T has a sectional structure as shown in FIG. 5A to FIG. 5C, and the transfer mark layer 16 having a multiplicity of transfer marks M, M, . . . is peelably adhered and held on the surface side (lower side in FIG. 5B and FIG. 5C) of the base tape 15. The drawing is intended to ease the understanding, and it is schematically magnified in the thickness direction. Actually, the thickness of the mark transfer tape T is like a thin film, and the boundary of layers is not as clear as shown in the drawing.

The base tape 15 functions as support base until the transfer mark M is transferred on the transfer area, and is treated for parting on both face and back sides, that is, it is a film tape of plastic material or paper material with surface treatment for separating or peeling from the overlaying adjacent layer or material, and a non-elongating flexible film is preferably used.

Specifically, the base tape 15 is preferably composed of polyethylene terephthalate (PET), polyethylene, polypropylene or other plastic film, and its thickness is set at about 4 to 100 μm.

The parting treatment applied on the face and back sides of the base tape 15 is coating with parting agent such as silicone parting agent or fluorine parting agent, and when the mark transfer tape T is rolled and collected, adhesion of the transfer mark layer 16 and back side of the base tape 15 is effectively prevented, and the transfer mark layer 16 can be easily separated or peeled from the base tape 15 at the time of transfer.

The transfer mark layer 16 is a laminated structure formed by laminating a surface forming layer 17, a mark array layer 18, and a pressure-sensitive adhesive layer 19 sequentially and integrally. The transfer mark layer 16 has transfer marks M, M, . . . formed continuously in the overall length of the base tape 15, and can be cut off properly by transfer operation of the transfer head H at the time of mark transfer.

Herein, required quality properties for the transfer mark layer 16 include, for example, the following.

1) Transfer property: Ease of transfer of the portion of the transfer mark layer 16 pressed by the transfer head H on the transfer area;

2) Cutting property: Ease of transfer and cutting of only the portion of the transfer mark layer 16 pressed by the transfer head H (if the cutting property of the transfer mark layer 16 is poor, the position of the transfer mark layer 16 not to be transferred may be also transferred);

3) Adhering property: Adhesion of transfer mark layer 16 on transfer area;

4) Writing property: Ease of writing by pencil, ball-point pen or other writing tool on the transferred sheet of transfer mark layer 16;

5) Aging stability: Fastness of ink to be free from discoloration or oozing when written on by writing tool on transferred sheet of transfer mark layer 16; and

6) Smoothness: Smoothness, being free from surface undulations, of transfer mark layer 16 after transfer.

To provide the transfer mark layer 16 with these quality properties depending on the purpose, various blending agents described below may be properly combined.

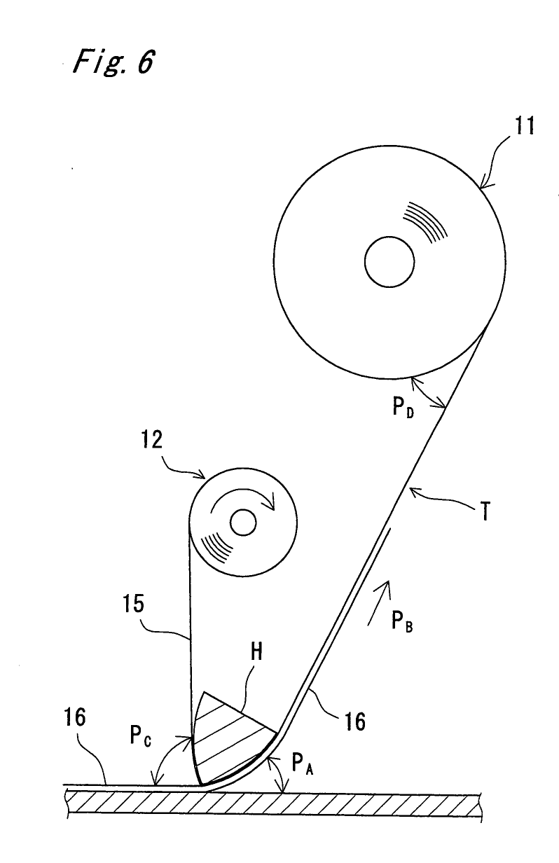

Referring specifically to FIG. 6, the adhesive force PA of the pressure-sensitive adhesive layer 19 on the transfer area such as sheet of paper, the rupture strength PB of the transfer mark layer 16, the adhesive force PC of the transfer mark layer 16 and base tape 15, and the adhesive force PD of the pressure-sensitive adhesive layer 19 and base tape 15 are set in the relation of PA≧PB≧PC≧PD.

This setting condition is the basic condition required for the mark transfer tape T used as being installed in the mark transfer tool 1, and regardless of the pressing transfer operation condition by the transfer head H (for example, inclination angle and active pressure of the transfer head H), it is the condition required for the transfer mark layer 16 to be smoothly peeled from the base tape 15 and transferred to the transfer area.

Further, as the specific condition required corresponding to the characteristic of the transfer mark layer 16, first, the elongation rate of the transfer mark layer 16 is set in a visual deformation allowable range of the transfer mark M at the time of pressing and transferring of the transfer mark layer 16 by the transfer head H.

Moreover, when the transfer mark layer 16 formed as a laminated structure, as in the embodiment, comprising the surface forming layer 17, mark array layer 18, and pressure-sensitive adhesive layer 19, as the specific condition, the elongation rate of the mark array layer 18 is set larger than the elongation rate of the surface forming layer 17, and the rupture strength of the mark array layer 18 is set smaller than the rupture strength of the surface forming layer 17.

That is, the present inventors conducted various tests and studies in order to seek the most important quality characteristic required in the transfer mark layer 16 as the mark transfer tape T. As a result, the inventors found that the quality characteristic about the elongation rate of the transfer mark layer 16 itself, and the quality characteristic about the elongation rate and rupture strength of the mark array layer 18 and surface forming layer 17 are most important.

Herein, the elongation rate and rupture strength are expressed by the values measured according to JIS (Japanese Industrial Standards) K 6730, by using the sheet samples of constituent materials of the layers 16, 17, 18 printed on peeling sheets.

First, the condition of setting the elongation rate of the transfer mark layer 16 in a visual deformation allowable range of the transfer mark M at the time of pressing and transferring of the transfer mark layer 16 by the transfer head H is the most important design condition for the mark transfer tape T having the visual effect as the principal function. Herein, the visual deformation allowable range of the transfer mark M is a range of the contour shape of the transfer mark transferred on the transfer area from the base tape 15 to be regarded substantially identical without visually spoiling the initial shape.

Therefore, the visual deformation allowable range is not determined generally, but is determined corresponding to a specific mark format such as characters, signs, symbols or combination thereof for composing the transfer mark M.

For example, in the case of a transfer mark M composed of letters or line drawings densely arranged in the lengthwise direction (running direction) of the mark transfer tape T, the visual deformation allowable range of the transfer mark M tends to be narrower (for example, maximum 3% or less), or in the case of a transfer mark M of single color without pattern, the visual deformation allowable range of the transfer mark M tends to be wider (for example, within maximum 50%).

In the shown embodiment, in the case of transfer mark SEED composed of alphabetic letters, as the condition for transferring the contour shape of alphabetic letters and interval of alphabetic letters on the transfer area without substantially spoiling the format adhered and held on the base tape 15, the elongation rate of the transfer mark layer 16 must be set within about 3%.

Next, the condition of setting the elongation rate of the mark array layer 18 same as or larger than the elongation rate of the surface forming layer 17, and the rupture strength of the mark array layer 18 same as or smaller than the rupture strength of the surface forming layer 17 is the specific design condition for realizing the most important design condition for the mark transfer tape T in this embodiment. This specific condition is the result obtained by testing and proving that the portion pressed by the transfer head H can be transferred favorably without causing cut or crack in the mark array layer 18, even in a transfer operation by a relatively weak pressing force of the transfer head H, as a result of tests and studies by the inventors. In other words, when the elongation rate of the mark array layer 18 is smaller than the elongation rate of the surface forming layer 17, there is a high possibility of crack forming in the mark array layer 18. When the rupture strength of the mark array layer 18 is larger than the rupture strength of the surface forming layer 17, the mark array layer 18 is not cut at desired position at the time of transfer, and the mark array layer 18 is hardly transferred in a perfect form.

In succession, the composition of the layers 17, 18 and 19 of the transfer mark layer M is specifically described below.

The surface forming layer 17 makes it easy to form (specifically, to print) the mark array layer 18, and has a function of adhering and holding the transfer mark layer 16 on the surface of the base tape 15, and also forms its surface portion after transfer of the transfer mark M. The thickness of the surface forming layer 17 is set at 5 to 40 μm, preferably 7 to 20 μm.

The surface forming layer 17 is made of a transparent adhesive material. That is, the surface forming layer 17 is preferably made of a see-through transparent resin composition of so-called dry type having a certain adhesion holding property on a parting treated surface of the base tape 15 and suited to surface layer after parting.

This resin composition is a synthetic resin or natural resin dissolved, as required, in a solvent, and besides, moreover, surface active agent, aging retardant, light stabilizer, or filler for improving writing property may be properly used.

The resin to be used is preferably one or more types of rubber-like resin so that the elongation rate and rupture strength of the surface forming layer 17 may satisfy the above conditions in relation between the elongation rate and rupture strength of the mark array layer 18, and further by combining rubber-like resin and glass-like resin, the surface forming layer 17 may be provided with more excellent properties in flexibility, writing property and cutting property.

In particular, the blending rate of rubber-like resin and glass-like resin contributes greatly to determination of elongation rate of the transfer mark layer 16.

Examples of rubber-like resin include styrene-butadiene-styrene block copolymer (SBS), styrene-ethylene-butylene-styrene block copolymer (SEBS), styrene-butadiene rubber, styrene-isoprene-styrene block copolymer (SIS), styrene-ethylene/propylene block copolymer (SEP), urethane rubber, fluororubber, acrylonitrile-butadiene rubber, ethylene-vinyl acetate copolymer, ethylene-ethylene acrylate copolymer, chlorosulfonated polyethylene, and cyclized rubber. A plasticizer may be used as required.

The glass-like resin is preferred to have a melting point or softening point of 100° C. or less and a high hardness, and usable examples include saturated or unsaturated alicyclic hydrocarbon resin, styrene-acrylic copolymer resin, ketone resin, vinyl chloride-vinyl acetate copolymer resin, polyethylene, polypropylene, and other polyolefin resins.

To form the surface forming layer 17, when using both rubber-like resin and glass-like resin, by adjusting their blending rate, the elongation rate of the surface forming layer 17 and also of the transfer mark layer 16 is set to the optimum value in the visual deformation allowable range.

The blending rate of the rubber-like and glass-like resins differs with the elongation rate and other properties of the rubber-like resin and glass-like resin to be used, but usually, in 10 parts by weight of the rubber-like resin, the glass-like resin is used by 2 to 30 parts by weight, preferably 5 to 15 parts by weight.

In the surface forming layer 17, light diffusion agent or coloring agent may be blended, and a translucent or colored surface forming layer 17 may be formed, but from the viewpoint of visual recognition of the mark array layer 18, the entire surface forming layer 17 is preferred to be colorless and transparent.

The surface forming layer 17 is formed by applying a resin composition for forming a surface forming layer on the base tape 15, by any known process using blade coater, roll coater, air knife coater, bar coater, gravure coater, etc.

The mark array layer 18 is composed of multiple marks (alphabetic letter mark SEED in the shown example) M′, M′, M′, . . . consecutively and peelable arranged at specific intervals in the running direction of the base tape 15, and is specifically printed and formed on the surface forming layer 17 by a known printing technology. The thickness of the mark array layer 18 is set at 0.1 to 5 μm, preferably 0.3 to 1.0 μm.

As the ink for forming the mark array layer 18, any ink composed of resin and coloring matter dissolved or dispersed, as required, in a solvent may be used.

As the resin used in the ink, it is preferred to use a rubber-like resin so that the elongation rate and rupture strength of the mark array layer 18 may satisfy the above conditions in the relation between the elongation rate and rupture strength of the surface forming layer 17 and pressure-sensitive adhesive layer 19, and the same resins as used in forming the surface forming layer 17 may be used. That is, one or more types of ordinary synthetic rubber or rubber-like resin may be used, such as styrene-butadiene-styrene block copolymer (SBS), styrene-ethylene-butylene-styrene block copolymer (SEBS), styrene-butadiene rubber, styrene-isoprene-styrene block copolymer (SIS), styrene-ethylene/propylene block copolymer (SEP), urethane rubber, fluororubber, acrylonitrile-butadiene rubber, ethylene-vinyl acetate copolymer, ethylene-ethylene acrylate copolymer, chlorosulfonated polyethylene, and cyclized rubber. As required, further, a plasticizer may be used.

AS the coloring matter, any known material used in printing ink may be used appropriately.

The printing method of the mark array layer 18 may be any known printing technology, specifically including traditional printing techniques such as gravure (intaglio) printing, typographic (letterpress) printing, offset printing, screen printing, ink jet printing, and tampon printing, and latest printing techniques such as reverse roll coat, direct coat, other coater methods, spray paint, electrostatic paint, flow coat, roller coat, immersion coat, laser printer, heat transfer, ink jet printer, and other methods, which may be properly selected and employed depending on the properties of the forming area (surface forming layer 17 in the shown case).

By such printing method, the mark array layer forming ink is printed and dried on the surface forming layer 17, and the mark array layer 18 is printed and formed on the surface forming layer 17.

The pressure-sensitive adhesive layer 19 presses and adheres the transfer mark layer 16 on the transfer area, and forms a surface layer of mark transfer tape T before transfer, and this pressure-sensitive adhesive layer 19 is made of a pressure-sensitive adhesive transparent material, that is, the pressure-sensitive adhesive layer 19 is preferably made of a so-called dry type transparent see-through adhesive having a pressure-sensitive adhesive property to the transfer area and suited to surface layer before parting. The thickness of the pressure-sensitive adhesive layer 19 is set at 0.5 to 5.0 μm, preferably 1.0 to 3.0 μm.

The adhesive as the constituent material for the pressure-sensitive adhesive layer 19 is any known adhesive, for example, rubber adhesive blending natural rubber, isoprene rubber, styrene butadiene rubber, or the like, and adhesive agent (rosin resin, terpene resin, terpene phenol resin), or acrylic adhesive mainly composed of (meth)acrylic ester.

The pressure-sensitive adhesive layer 19 is formed by a known coating method, by applying a rubber adhesive or acrylic adhesive on the surface forming layer 17 having the mark array layer 18.

The transfer mark layer 16 having such laminated structure is peelably and separably adhered and held on a parting treated surface (lower side in FIG. 5B and FIG. 5C) of the base tape 15, as shown in FIG. 5A to FIG. 5C, by way of the surface forming layer 17.

The mark transfer tape T in the shown embodiment is, as shown in FIG. 5A, fabricated as a band having a tape width dimension of plural mark transfer tapes T, T, . . . , and is cut and formed in a width of one tape T by a slitter or other cutting device.

In a specific forming method of transfer mark layer 16, after applying and forming the surface forming layer 17 on the surface of the base tape 15 as mentioned above, the mark array layer 18 is printed and formed on the surface of the surface forming layer 17, and finally the pressure-sensitive adhesive layer 19 is applied and formed thereon.

The transfer head H is designed to press the mark transfer tape T on a correction area such as sheet of paper, and is provided in the leading end portion of the cartridge case 10, and functions to guide and press the mark transfer tape T.

The transfer head H specifically comprises a head main body 30, a head holding part 31, and a rotation manipulation part 32, and is designed as a rotary head structure having the head main body 30 held rotatably about its axial center.

The head main body 30 is to press and transfer the mark transfer tape T, and has a shape suited to transfer accurately on a desired transfer position, that is, a pointed shape having a pointed leading end.

The head main body 30 of the shown embodiment is a thin plate body having a rectangular shape slightly wider than the mark transfer tape T, and has somewhat pointed shape as seen from the side, that is, a narrow-end taper sectional shape becoming gradually thin toward the leading end.

The head main body 30 has both flat surfaces 30a, 30b forming the tape running surface, and its leading end edge 25 is a leading end pressing part for pressing the mark transfer tape T as mentioned above. This leading end pressing part 25 is a linear edge orthogonally crossing with the tape running direction in the tape running surfaces 30a, 30b. At both side edges of the head main body 30, further, guide flanges 33, 33 for guiding the running of the mark transfer tape T are formed.

When the thickness of the plate body forming the head main body 30 is relatively small, the taper shape as shown in the drawing is not particularly needed, but the thickness may be uniform throughout the entire longitudinal direction, and it is enough, in short, as far as the leading end pressing part 25 of the head main body 30 has a thick (pointed) structure enough to indicate the transfer position accurately.

Further, the material characteristic of the head main body 30 is set in consideration of the pressing action of the mark transfer tape T required in the leading end pressing part 25. In the shown embodiment, it is required that the entire transfer mark M of the mark transfer tape T should be uniformly adhered and fixed on the transfer area, and it is desired that the head main body 30 has an elastic deforming characteristic in the pressing direction of the mark transfer tape T, and the transfer head H is formed as an elastic head.

Besides, in the leading end side position of the head main body 30, a borne part 35 is integrally formed as a main body support part.

A head holding part 31 supports the head main body 30 rotatably about its axial center, and specifically comprises the borne part 35 as the main body support part and a bearing part 36 provided in the cartridge case 10.

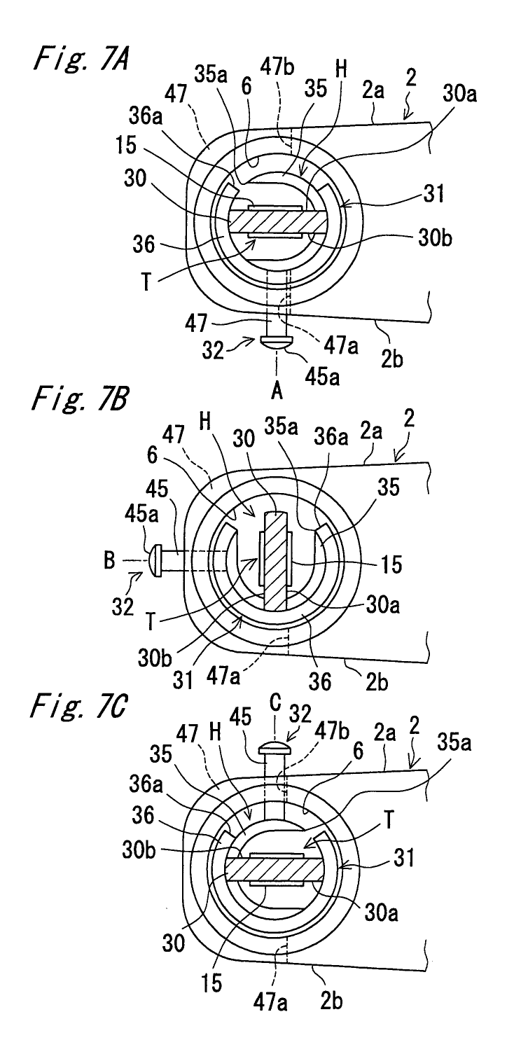

The borne part 35 is a cylindrical part formed concentrically and integrally with the head main body 30, as shown in FIG. 7A to FIG. 7C, and specifically it is formed as an arc-shaped section, specifically having in part a setting opening 35a of the mark transfer tape T on the head main body 30.

The bearing part 36 is formed integrally in the leading end portion of the cartridge case 10. This bearing part 36 has a tubular shape having an inner circumference corresponding to the outer circumference of the borne part 35, as shown in FIG. 7A to FIG. 7C, and same as the borne part 35, it has in part a setting opening 36a of the mark transfer tape T on the head main body 30. The borne part 35 is slidably and rotatably supported on the bearing part 36, and the head main body 30 is freely rotatable about its axial center in a specified rotation angle range described below.

The rotation manipulation unit 32 is to determine the rotating direction position of the head main body 30, and functions also as a head position indicator showing the tape pressing and transfer position of the head main body 30.

The rotation manipulation unit 32 is a circular columnar bar, and mainly comprises an operation lever 45 having an operation knob 45a at its leading end. The operation lever 45 is linearly extended outward in the radial direction from the axial center of the borne part 35, and projects oppositely to outside of the case 2, by way of a slit-like insertion part 46 and operation guide part 47 provided at corresponding positions of the bearing 36 and case 2. In this case, the insertion part 46 of the bearing part 36 functions also as stopper of the head main body 30 in the axial direction.

The rotation direction disposing position of the operation lever 45 in the head main body 30 is set in relation to the tape pressing transfer position of the head main body 30, and the insertion part 46 and operation guide part 47 and extended and set in the peripheral direction so as to allow the operation lever 45 to move in the rotating direction of the head main body 30. In particular, the operation guide part 47 of the case 2 defines the rotation direction operating range of the operation lever 45, and is designed to control the tape pressing transfer position of the head main body 30.

Next, the relation between the operation lever 45 and tape pressing transfer position of the head main body 30 is explained as the relation with the operation guide part 47. In the shown embodiment, the structure of the rotation direction operation range defining part of the operation guide part 47 is set as follows by referring to FIG. 7.

(a) When the operation lever 45 is engaged with one end 47a of the operation guide part 47, that is, in the vertical downward position (first defining position A shown in FIG. 7A), the head main body 30 of the transfer head H is at an angular position for guiding so that the leading end pressing part 25 may set the mark transfer tape T nearly opposite to the gripping surfaces 2a, 2b of the case 2, that is, the face and back sides of the mark transfer tape T may be directed nearly same as (parallel to) the direction of the gripping surfaces 2a, 2b.

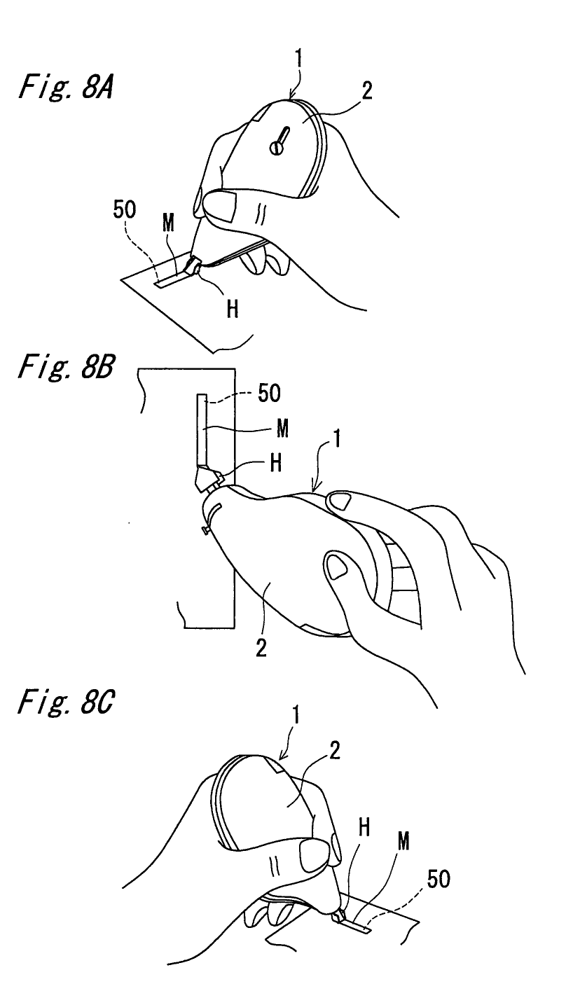

In this case, the new mark transfer tape T paid out from the pay-out reel 11 is at the lower side of the head main body 30, that is, in a suitable state for lateral pulling use by a right-handed user (see FIG. 8A).

(b) When the operation lever 45 is at an intermediate position of the both ends 47a, 47b of the operation guide part 47, that is, in a horizontal position (second defining position B in FIG. 7B), the head main body 30 of the transfer head H is at an angular position for guiding so that the leading end pressing part 25 may set the mark transfer tape T remaining in the winding position of the pay-out reel 11 and winding reel 12, that is, the face and back sides of the mark transfer tape T may be directed nearly vertical to (orthogonal to) the direction of the gripping surfaces 2a, 2b.

In this case, the new mark transfer tape T paid out from the pay-out reel 11 is at the left side of the head main body 30, that is, in a suitable state for vertical pulling use (see FIG. 8B).

(c) When the operation lever 45 is engaged with other end 47b of the operation guide part 47, that is, in the vertical upward position (third defining position C shown in FIG. 7C), the head main body 30 of the transfer head H is at an angular position for guiding so that the leading end pressing part 25 may set the mark transfer tape T nearly opposite to the gripping surfaces 2a, 2b of the case 2, in an upside down state of the case (a).

In this case, the new mark transfer tape T paid out from the pay-out reel 11 is at the upper side of the head main body 30, that is, in a suitable state for lateral pulling use by a left-handed user (see FIG. 8C).

As clear from the description herein, the direction of the operation lever 45 directly and visually indicates the opposite direction of the use mark transfer tape T (the function as head position indicator), and the user can check the tape pressing transfer position of the head main body 30 by referring to the direction of the operation lever 45.

The rotation direction operating range of the operation guide part 47 (about 180 degrees at maximum in the shown case) can be set freely at a desired value from a small angular range to a large angular range, in consideration of relation between the operation lever 45 and the tape pressing transfer position of the head main body 30.

By the mark transfer tool 1 having such structure, to transfer the transfer mark on the mark transfer tape T on a desired transfer area 50 in a sheet of paper or the like, whether the user is right-handed or left-handed as mentioned above, the operation lever 45 is rotated depending on the purpose, and an appropriate tape pressing transfer position of the head main body 30 of the transfer head H (specifically, first defining position A shown in FIG. 7A, second defining position B shown in FIG. 7B, and third defining position C shown in FIG. 7C) is selectively set, and the gripping surface of the case 2 corresponding to the position (the standard gripping surfaces are the face and back sides 2a, 2b of the case 2, but other proper position or surface of the case 2 may be gripped depending on the purpose) are gripped by the hand and fingers, so that the manner of use as shown in FIG. 8A to FIG. 8C may be realized.

That is, regardless of the method of use, the gripping surfaces of the case 2 can be gripped and held like a writing tool, and the leading end pressing part 25 of the transfer head H is tightly pressed against the transfer start end of the transfer area 50 in the sheet of paper or the like, and the case 2 is directly moved along the sheet of paper by a specified distance and stopped.

Specifically, in a previous mark transfer operation end state, the transfer head H is tightly pressed against the transfer start end of the transfer area 50, and the case 2 is directly moved along the sheet of paper and stopped when transfer of one (or plural) transfer mark M is complete, and the transfer head H is lifted from the transfer area 50.

By this operation, the transfer mark M of the mark transfer tape T at the leading end pressing part 25 of the transfer head H is peeled from the base tape 15, and is transferred on the correction area 50, and the used mark transfer tape T from which the transfer mark M is peeled, that is, the base tape 15 is taken up and collected on the winding reel 12.

As mentioned above, since the elongation rate of the transfer mark layer 16 is set within the visual deformation allowable range of the transfer mark M at the time of pressing and transferring of the transfer mark layer 16 by the transfer head H, the transfer mark M is transferred on the transfer area from the base tape 15 without visually spoiling the contour shape.

Besides, since the elongation rate of the mark array layer 18 in the transfer mark layer 16 is set same as or larger than the elongation rate of the surface forming layer 17, crack or cut of the transfer mark M at the time of transfer can be effectively prevented, and moreover since the rupture strength of the mark array layer 18 is set same as or smaller than the rupture strength of the surface forming layer 17, favorable cutting property at desired position of the transfer mark layer 16, that is, favorable transfer of only the desired transfer mark M can be assured.

In the mark transfer tool 1 of the embodiment, since the mark transfer tape T has an exchangeable cartridge structure, by preparing a plurality of tape cartridges C having mark transfer tapes T of plural different transfer marks M, M, M . . . , proper transfer marks M, M, . . . can be transferred and used depending on the purpose.

Further, for example, when an aromatic component is contained in the material of the transfer mark M, that is, the transfer mark layer 16, the transfer mark M may be used as an aromatic mark having an aromatic effect, or when an antibacterial component is contained, it may be presented as an antibacterial mark having an antibacterial effect, and thus in addition to the initial indication effect of the mark, accessory effects may be exhibited additionally.

That is, in the former case of aromatic mark M, by dispersion of a refreshing fragrance, it may have effects of recovery from fatigue, stress relief, or metal stability, and it may be effectively used, for example, in aroma therapy. Some of the aromatic components may also have antibacterial effect, bactericidal effect or insecticidal effect, and hence the transfer mark M having such effects may be obtained.

In the latter case of antibacterial mark M, the bacterial growth inhibitory effect is effectively exhibited by the antibacterial action, and it may be effectively used as the indication mark to be adhered to devices and handling positions touched by many unspecified people, for example, operation switches of electrical appliances, paper punch other hand-held stationary goods, whiteboard marker, and writing tools.

In these cases, the aromatic component and antibacterial component are contained at least in one constituent material of surface forming layer 17, mark array layer 18 and pressure-sensitive adhesive layer 19 of the transfer mark layer 16 composing the transfer mark M.

Embodiment 2

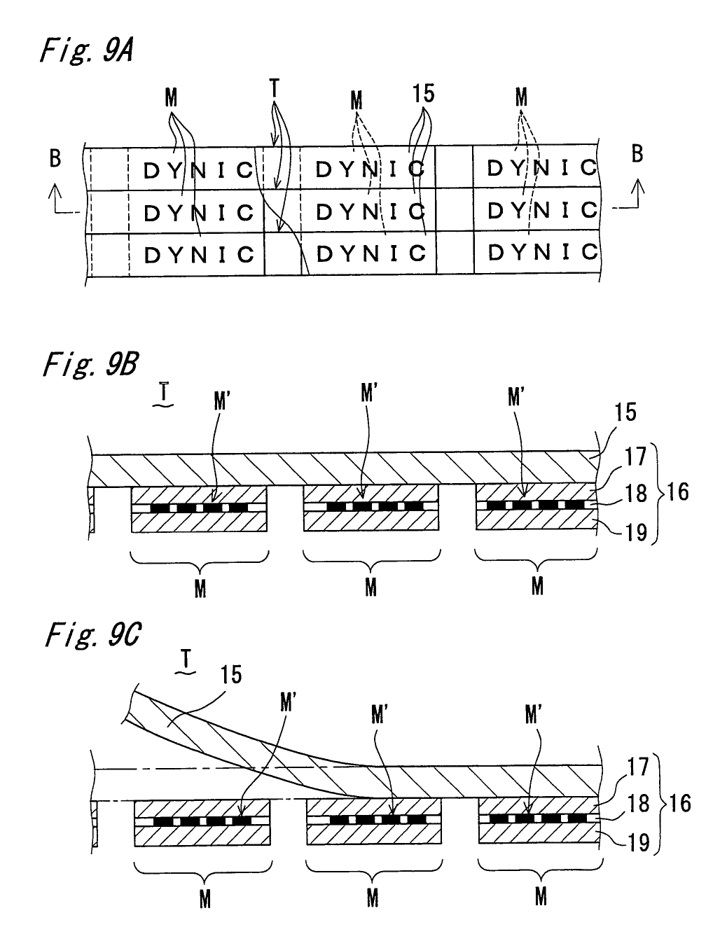

This embodiment is shown in FIG. 9Ato FIG. 9C, and is similar to embodiment 1, except that the structure of mark transfer tape T is modified.

That is, in the mark transfer tape T of embodiment 1, as mentioned above, the transfer mark layer 16 is formed continuously in the overall length of the base tape 15, but in the mark transfer tape T of this embodiment, as shown in FIG. 9A to FIG. 9C, transfer marks for composing the transfer mark layer 16 (in the shown example, only indication marks composed of alphabetic letter DYNIC) M, M, . . . are independently and peelably adhered and held at specified intervals on the surface of the base tape 15.

In this structure, by the same transfer operation as explained in embodiment 1, in a previous mark transfer operation end state, the transfer head H is tightly pressed against the transfer start end on the transfer area 50, and the case 2 is directly moved along the sheet of paper and stopped when transfer of one (or plural) transfer mark m is complete, and the transfer head H is lifted from the transfer area 50.

By this operation, only one transfer mark M on the mark transfer tape T is peeled securely from the base tape 15, and is transferred on the correction area 50.

The other structure and operation are same as in embodiment 1.

Embodiment 3

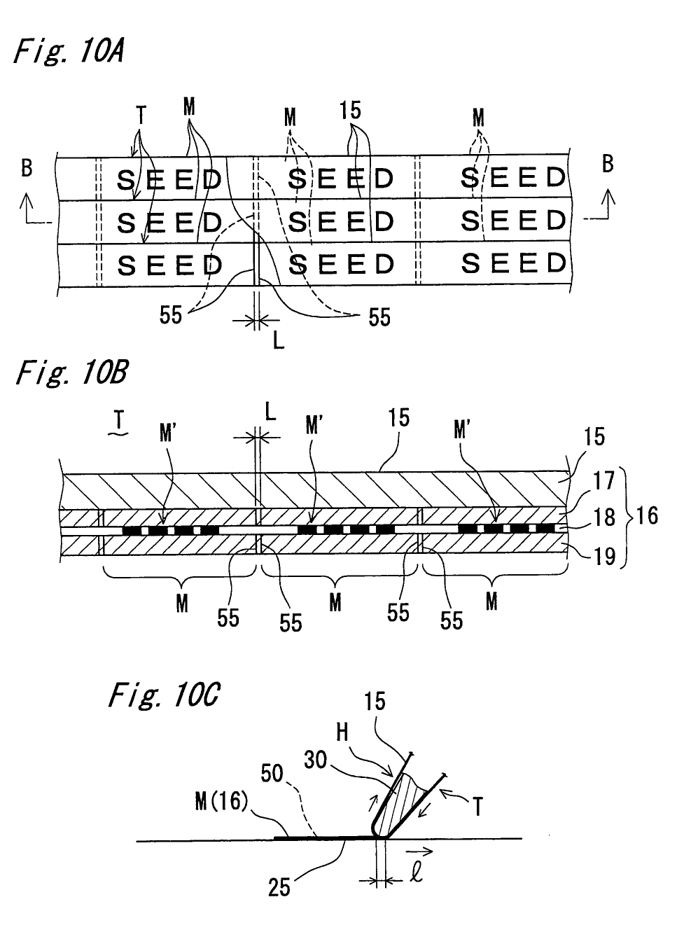

This embodiment is shown in FIG. 10A to FIG. 10C, and is similar to embodiment 1, except that the structure of mark transfer tape T is modified.

That is, in the mark transfer tape T of this embodiment, same as the mark transfer tape T of embodiment 1, the transfer mark layer 16 is formed continuously in the overall length of the base tape 15, but, as shown in FIG. 10A to FIG. 10C, at least two cutting lines 55, 55 are provided at specified interval between transfer marks M, M of the transfer mark layer 16, so that the transfer mark M can be cut off easily and securely at the time of transfer.

In the shown embodiment, two cutting lines 55, 55 are provided at specified interval in the middle of transfer marks M, M. These cutting lines 55, 55 are linearly extended and formed vertically to the longitudinal direction of the transfer tape T in the overall width of the transfer mark layer 16. The disposing interval L of the cutting lines 55, 55 is set larger than the pressing width 1 of the leading end pressing part 25 of the transfer head H (L>1).

In this structure, by the same transfer operation as explained in embodiment 1, in a previous mark transfer operation end state, the transfer head H is tightly pressed against the transfer start end on the transfer area 50, and the case 2 is directly moved along the sheet of paper and stopped when transfer of one (or plural) transfer mark M is complete, and the transfer head H is lifted from the transfer area 50. In this case, the stopping position of the mark transfer tool 1 is located so that the leading end pressing part 25 of the transfer head H is between the both cutting lines 55, 55.

By this operation, only one transfer mark M on the mark transfer tape T is peeled securely from the base tape 15 at the position of the cutting line 55, and is transferred on the correction area 50, and the cutting line is straight.

The other structure and operation are same as in embodiment 1.

Embodiment 4

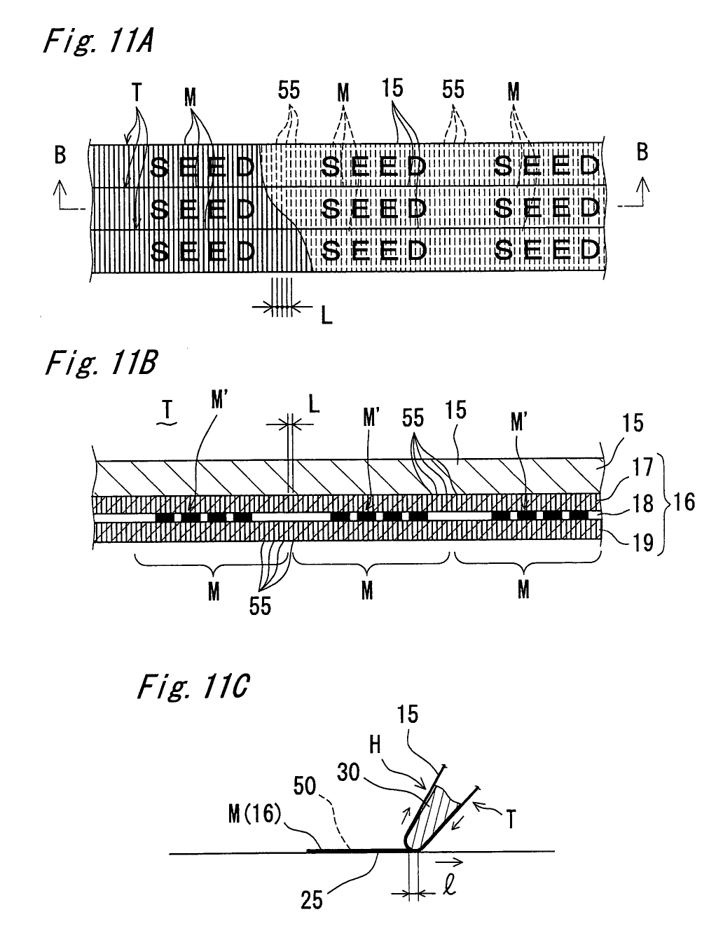

This embodiment is shown in FIG. 11A to FIG. 11C, and is similar to embodiment 3, except that the structure of mark transfer tape T is modified.

That is, in the mark transfer tape T of embodiment 3, two cutting lines 55, 55 are provided at specified interval between transfer marks M, M of the transfer mark layer 16, but in the mark transfer tape T of this embodiment, multiple cutting lines 5, 5, . . . are provided in the transfer mark layer 16 at specified interval in the overall length of the transfer mark layer 16.

In this structure, in the manufacturing process of the mark transfer tape T, the cutting lines 5, 5, . . . can be formed more simply and securely as compared with the case of embodiment 3.

In the transfer operation, only one transfer mark M on the mark transfer tape T is transferred on the correction area 50, and the cutting line is straight, same as in embodiment 3, and moreover, in this case, the stopping position condition of the mark transfer tool 1 is less strict than the condition in embodiment 3, and by lifting the mark transfer tool 1 when the leading end pressing part 25 of the head H is at an arbitrary position between the transfer marks M, M, the transfer mark M is securely peeled off from the base tape 15 at the position of the cutting line 55, and is transferred on the correction area 50, and therefore cutting is further easy and secure at the time of transfer of the transfer mark M.

The other structure and operation are same as in embodiment 3.

Embodiment 5

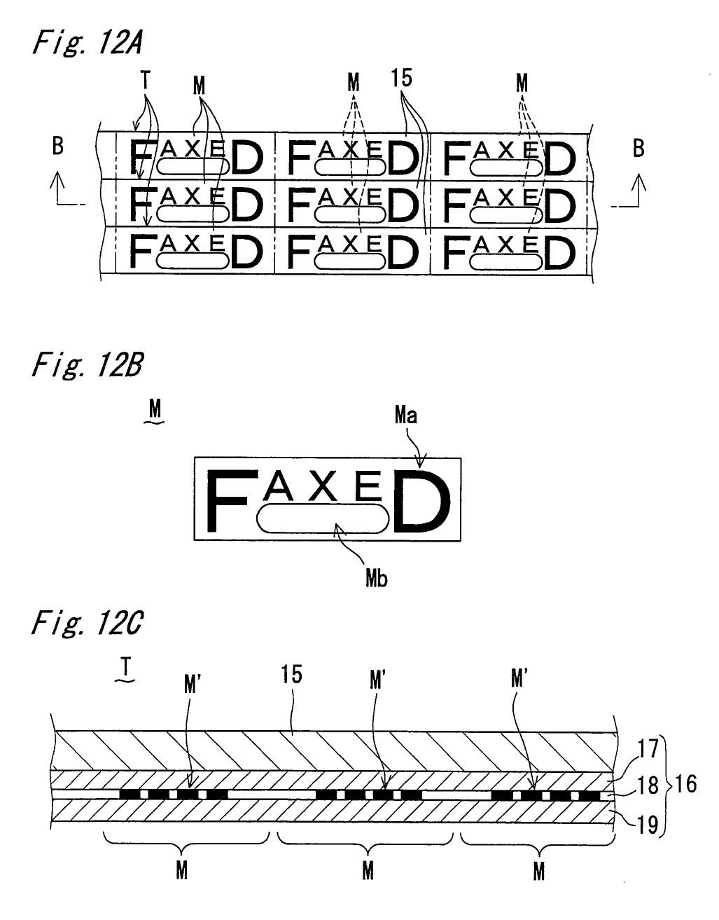

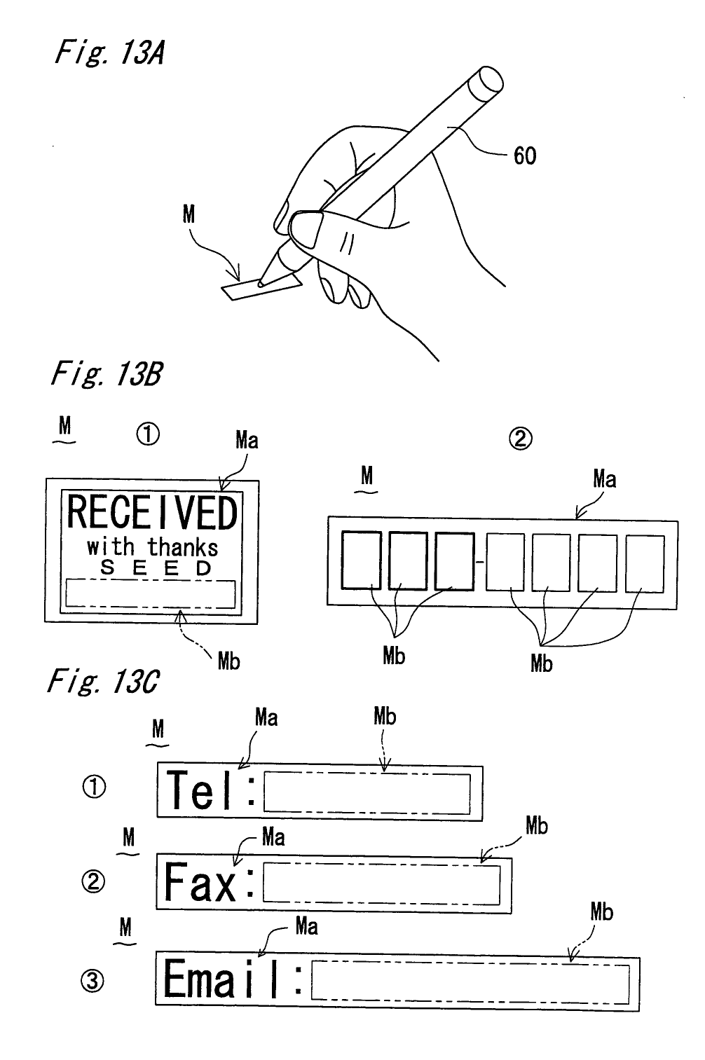

This embodiment is shown in FIG. 12A to FIG. 12C and FIG. 13A to FIG. 13C, and is similar to embodiment 1, except that the specific structure of mark transfer tape T is slightly modified.

That is, in the mark transfer tape T of embodiment 1 or 2, the transfer mark M is indication mark only (alphabetic letter SEED in embodiment 1, DYNIC in embodiment 2), whereas the mark transfer tape T of this embodiment has its transfer mark M composed of an indication mark Ma and an overwriting space Mb.

Specifically, as shown in FIG. 12B, the indication mark Ma is a designed alphabetic letter mark of FAXED, and the overwriting space Mb is a matching space of specified shape and size harmonized with the indication mark Ma FAXED (an elliptical contour frame area), and the date is to be written in this overwriting space Mb.

The indication mark Ma and overwriting space Mb form the mark array layer 18 of the transfer mark layer 16 same as in embodiment 1.

That is, as shown in FIG. 12A, the mark array layer 18 is composed of multiple marks (indication mark FAXED and accompanying elliptical overwriting space) M′, M′, M′, . . . arranged consecutively and peelable at specified intervals in the running direction of the base tape 15, and these marks M′, M′, M′, . . . are formed on the surface forming layer 17 by the known printing technology as mentioned above.

The surface forming layer 17 has the basic structure as mentioned above (the forming function of the mark array layer 18 and adhering and holding function of the transfer mark layer 16), and also has a function of allowing to overwrite by writing tool 60 such as ball-point pen on the overwriting space Mb, as a surface forming part of the transfer mark layer 16 after transfer of the transfer mark M.

For this purpose, the surface forming layer 17 is made of a material capable of exhibiting such functions. The surface forming layer 17 of the embodiment is preferably made of a resin material having a certain adhesion holding property on a parting treated surface of the base tape 15, being of so-called dry type suited to surface layer after parting, and having enough transparency for overwriting by a writing tool 60.

In the mark transfer tool 1 having such structure, by the same transfer operation as explained in embodiment 1, the transfer mark M on the mark transfer tape T is transferred on the transfer area 50, and as shown in FIG. 13A, a desired letter (a date in the shown example) can be overwritten by a writing tool 60 in the overwriting space Mb of the transfer mark M.

Thus, since the transfer mark M is composed of an indication mark Ma and an overwriting space Mb, it is possible to write, for example, on a material not to be written on directly by writing tool 60, or material not to be erased cleanly if once written on.

The other structure and operation are same as in embodiment 1.

Other specific examples of the transfer mark M (indication mark Ma and overwriting space Mb) are shown in FIG. 13B and FIG. 13C.

In FIG. 13B, same as above, the indication mark Ma and overwriting space Mb are integrated, in which (1) has an indication mark Ma “RECEIVED with thanks SEED” and a matching overwriting space Mb for entering the date beneath the mark.

Further, (2) has a rectangular mark Ma with seven overwriting spaces Mb consisting of with three cells enclosed with lines and four cells enclosed with thin lines for entering the Japanese postal code (consisting of seven digits).

In FIG. 13C, the indication mark Ma and overwriting space Mb are separate, that is, (1) is the indication mark Ma (Tel:) followed by a blank entry space Mb at the right side for entering the telephone number.

Next (2) is the indication mark Ma (Fax:) followed by a blank entry space Mb at the right side for entering the facsimile number.

Finally, (3) is the indication mark Ma (Email:) followed by a blank entry space Mb at the right side for entering the e-mail address.

Embodiment 6

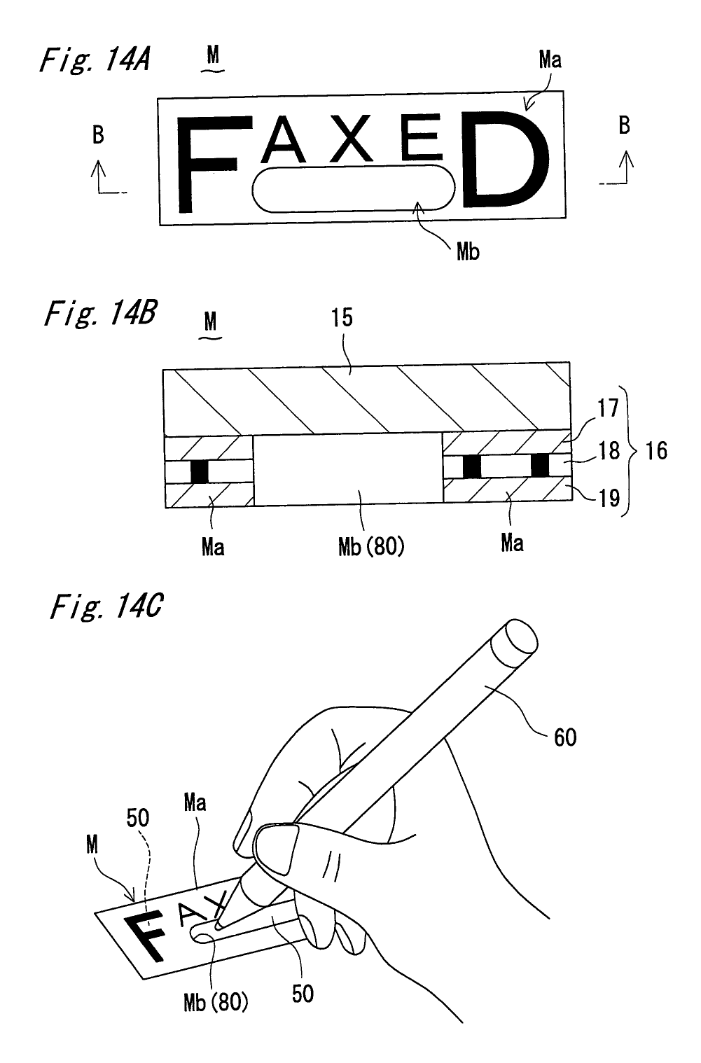

This embodiment is shown in FIG. 14A to FIG. 14C, and is similar to embodiment 5, except that the specific structure of mark transfer tape T is slightly modified.

That is, same as in embodiment 5, the transfer mark M is composed of indication mark Ma and overwriting space Mb, but in the transfer mark M of this embodiment, the overwriting space Mb is formed as a writing window 80 penetrating through the face and back sides of the transfer mark M as shown in FIG. 14B.

Therefore, since the overwriting space Mb is formed as a writing window 80, it is suited, for example, when the transfer area 50 is made of a material to be written on directly by writing tool 60, and its base color is desired to be used as background color of writing, or when the material of the surface layer 20 of the transfer mark M is not suited to overwriting by writing tool 60 or is a material impossible to write on.

The other structure and operation are same as in embodiment 5.

Embodiment 7

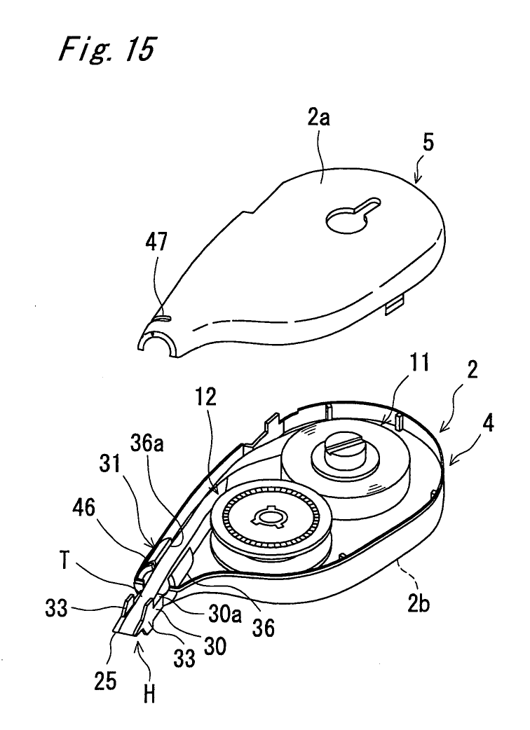

This embodiment is shown in FIG. 15, and the basic structure of mark transfer tool 1 is modified.

That is, the mark transfer tool 1 in the foregoing embodiments has the cartridge type or refill type structure having an exchangeable mark transfer tape T as consumable part, but this embodiment has a one-time disposable type structure having all components including the mark transfer tape T as consumable parts.

In the mark transfer tool 1 of the embodiment, a hand-held case 2 to be manipulated by one hand incorporates a pay-out reel 11 having a mark transfer tape T wound around it, and a winding reel 12 for collecting the mark transfer tape T after use, and a transfer head H is disposed at the leading end of the case 2, rotatably about its head axial center. The specific structure of the transfer head H is same as in embodiment 1, except for its mounting position.

Although not shown specifically, the case main body 4 of the case 2 incorporates, aside from the pay-out reel 11 and winding reel 12, principal basic components including the tape interlocking parts mutually cooperating with the both reels 11, 12, and clutch mechanism for synchronizing the pay-out speed and winding speed of the transfer tape T in the pay-out reel 11 and winding reel 12, which are assembled in one unit.

The other structure and operation are same as in embodiment 1.

Embodiment 8

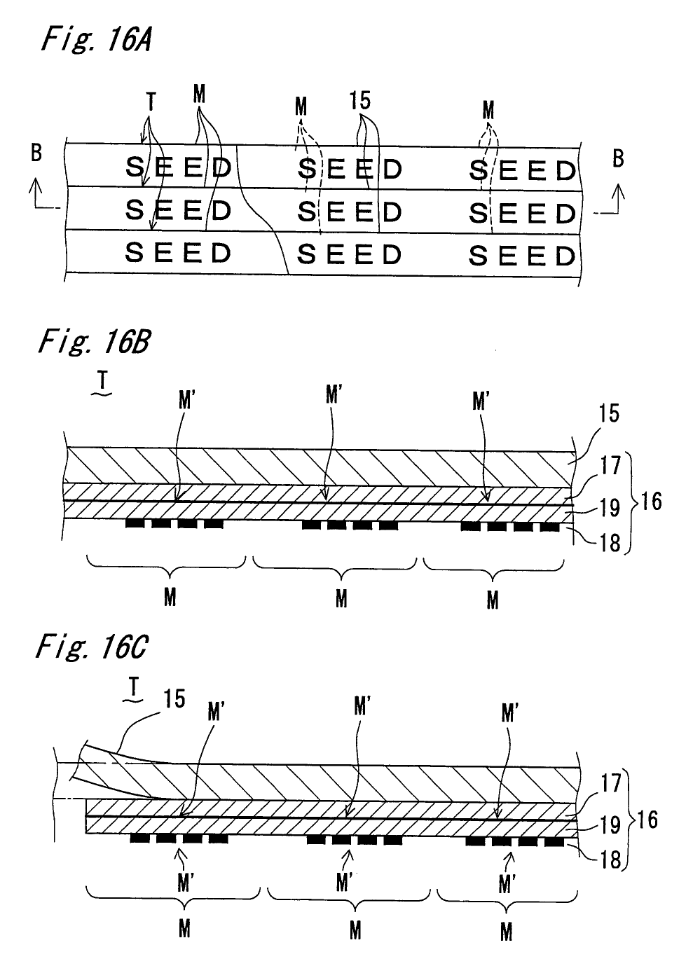

This embodiment is shown in FIG. 16A to FIG. 16C, and is similar to embodiment 1, except that the specific structure of mark transfer tape T is slightly modified.

That is, in the mark transfer tape T of this embodiment, the configuration is reverse to the case of the mark array layer 18 and pressure-sensitive adhesive layer 19 in the transfer mark layer 16 in embodiment 1, and the surface forming layer 17, pressure-sensitive adhesive layer 19, and mark array layer 18 are laminated and formed integrally in this sequence. Accordingly, the transfer mark layer 16 is adhered and held peelably and separably on a parting treated surface of the base tape 15 by way of the surface forming layer 17.

The other structure and operation are same as in embodiment 1.

Embodiment 9

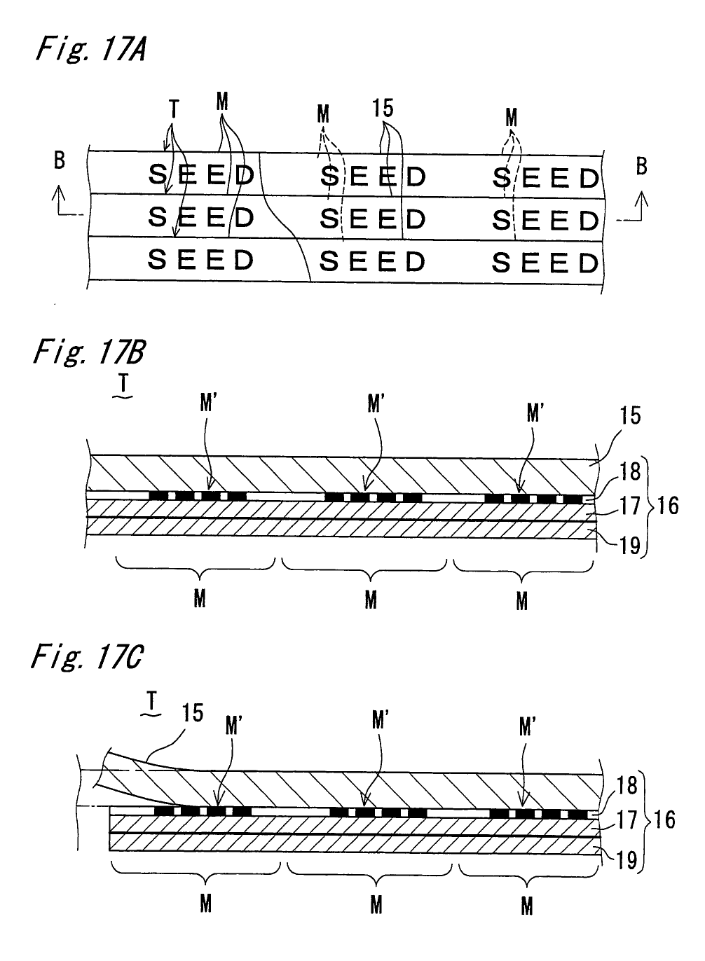

This embodiment is shown in FIG. 17A to FIG. 17C, and is similar to embodiment 1, except that the specific structure of mark transfer tape T is slightly modified.

That is, in the mark transfer tape T of this embodiment, the configuration is reverse to the case of the surface forming layer 17 and mark array layer 18 in the transfer mark layer 16 in embodiment 1, and the mark array layer 18, surface forming layer 17, and pressure-sensitive adhesive layer 19 are laminated and formed integrally in this sequence. Accordingly, the transfer mark layer 16 is adhered and held peelably and separably on a parting treated surface of the base tape 15 by way of the mark array layer 18.

In other words, the mark array layer 18 is directly printed and formed on a parting treated surface of the base tape 15, and at the time of mark transfer, therefore, the mark array layer 18 is peeled from the surface of the base tape 15, and a surface layer is formed directly.

In this relation, a light dispersion agent or coloring matter may be blended in the surface forming layer 17, and the surface forming layer 17 may be colored.

The other structure and operation are same as in embodiment 1.

Embodiment 10

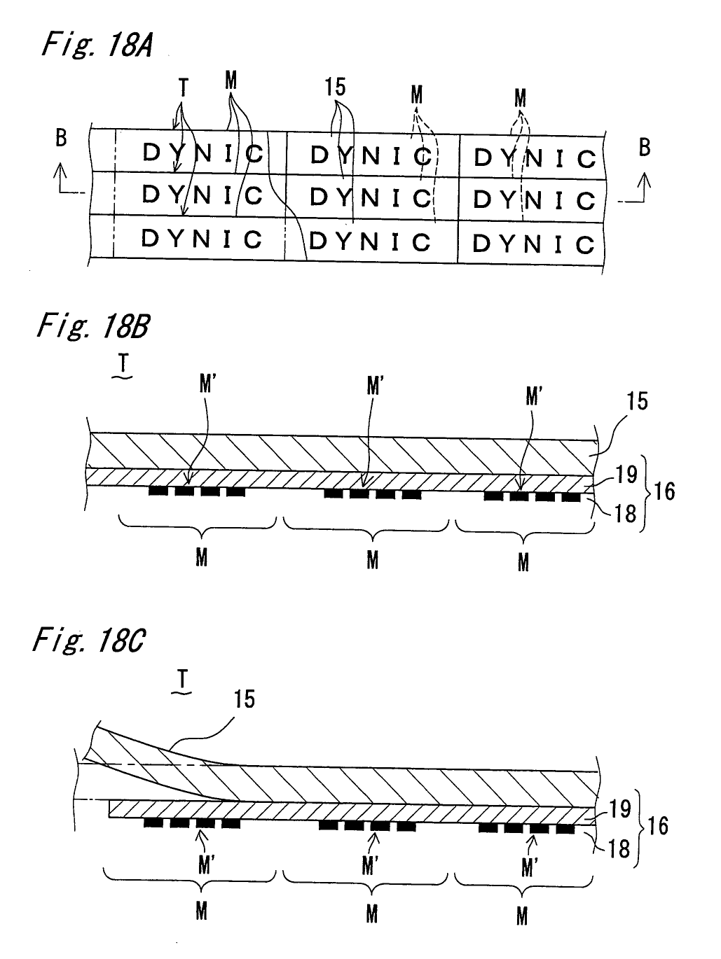

This embodiment is shown in FIG. 18A to FIG. 18C, and the structure of mark transfer tape T is modified.

That is, in the mark transfer tape T of this embodiment, as shown in FIG. 18A to FIG. 18C, the transfer mark layer 16 adhered and held at the surface side of the base tape 15 (the lower side in FIG. 18B and FIG. 18C) has a laminated structure integral with the pressure-sensitive adhesive layer 19 and mark array layer 18.

In this embodiment, the pressure-sensitive adhesive layer 19 functions also as the surface forming layer 17 in embodiment 1, and the mark array layer 18 is printed and formed on the surface of this surface forming layer 17.

The transfer mark layer 16 having such laminated structure is peelably and separably adhered and held on a parting treated surface of the base tape 15 (the lower side in FIG. 18B and FIG. 18C) by way of the pressure-sensitive adhesive layer 19.

In a specific forming method of the transfer mark layer 16, the pressure-sensitive adhesive layer 19 is applied and formed on the surface of the base tape 15, and the mark array layer 18 is printed and formed on the surface of this pressure-sensitive adhesive layer 19.

The other structure and operation are same as in embodiment 1.

Embodiment 11

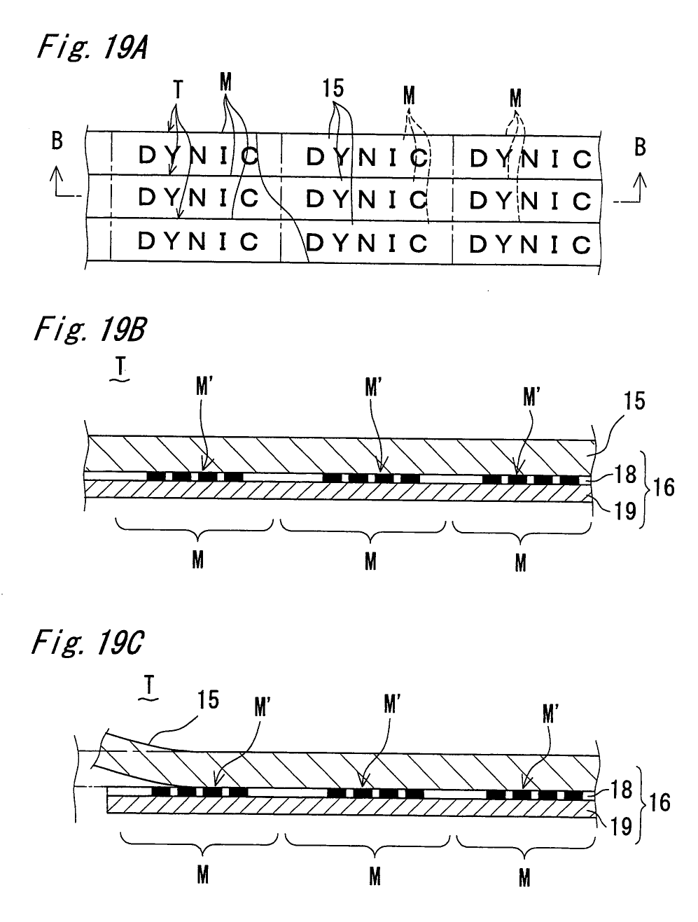

This embodiment is shown in FIG. 19A to FIG. 19C, and the structure of mark transfer tape T is modified.

That is, in the mark transfer tape T of this embodiment, as shown in FIG. 19A to FIG. 19C, the transfer mark layer 16 adhered and held at the surface side of the base tape 15 (the lower side in FIG. 19B and FIG. 19C) has a laminated structure integral with the mark array layer 18 and pressure-sensitive adhesive layer 19, and the surface forming layer 17 in the mark transfer tape T in embodiment 1 is omitted.

In other words, the transfer mark layer 16 is peelably and separably adhered and held on a parting treated surface of the base tape 15 by way of the mark array layer 18. That is, the mark array layer 18 is directly printed and formed on a parting treated surface of the base tape 15, and at the time of mark transfer, therefore, the mark array layer 18 is peeled from the surface of the base tape 15, and a surface layer is formed directly. The other structure and operation are same as in embodiment 1.

Embodiment 12

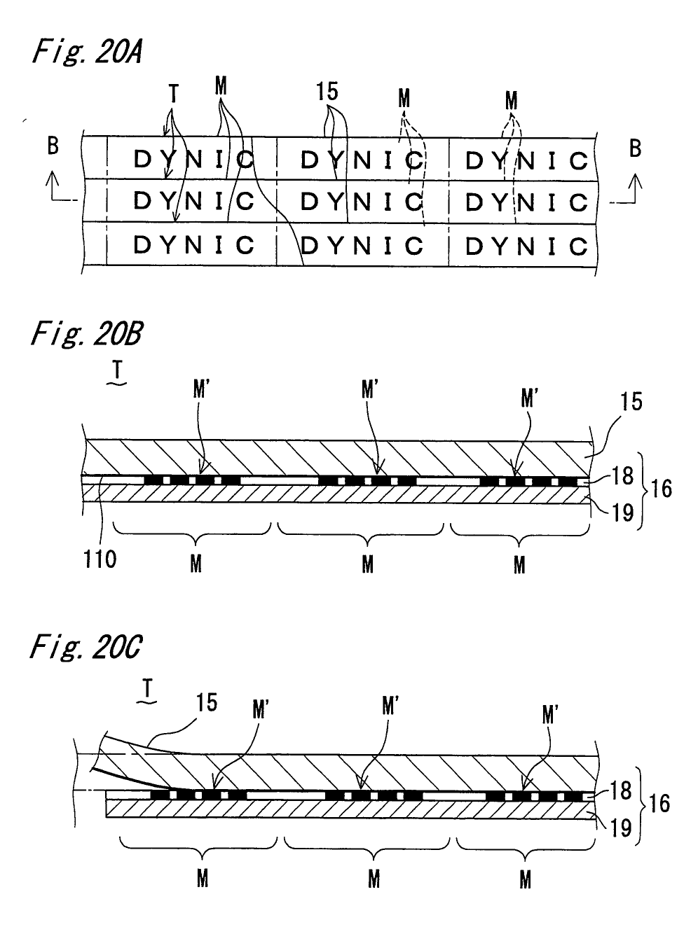

This embodiment is shown in FIG. 20A to FIG. 20C, and is similar to embodiment 9, except that the structure of mark transfer tape T is slightly modified.

That is, in the mark transfer tape T of this embodiment, as shown in FIG. 20A to FIG. 20C, the surface side of the base tape 15 (the lower side in FIG. 20B and FIG. 20C) has an adhesive treatment 110, and the mark array layer 18 is directly printed and formed on this surface. Therefore, at the time of mark transfer, this mark array layer 18 is peeled from the surface of the base tape 15, and a surface layer is formed directly.

The other structure and operation are same as in embodiment 11.

Embodiment 13

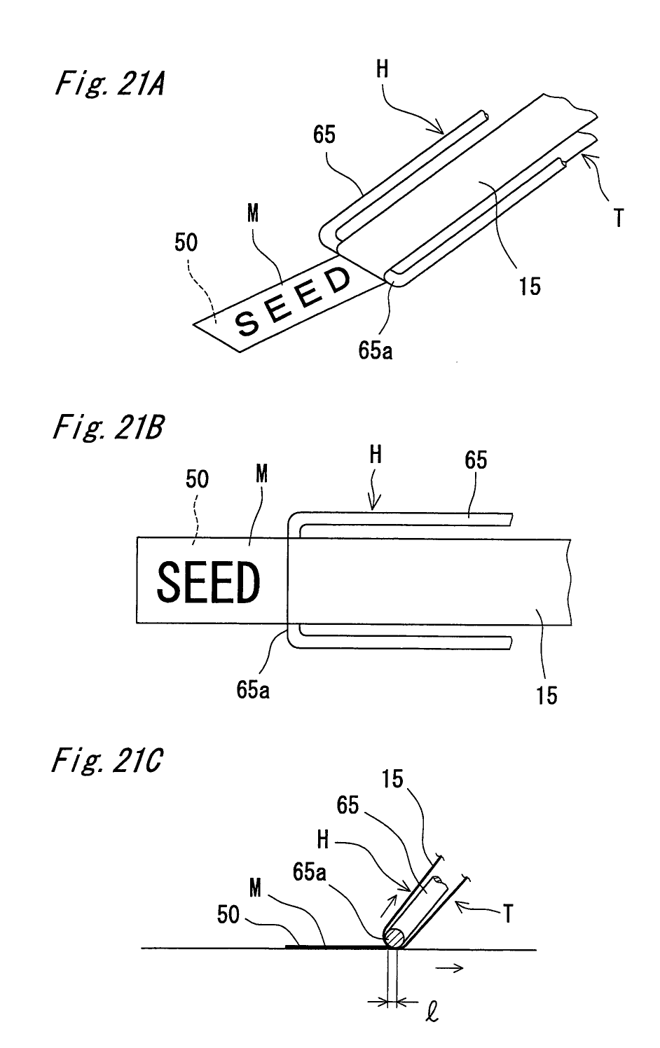

This embodiment is shown in FIG. 21A to FIG. 21C, and the structure of transfer head H of mark transfer tool 1 is modified.

That is, the transfer head H of this embodiment is a wire head as shown in the drawing. Specifically, this transfer head H is made of wire 65 of proper elastic metal such as stainless steel, being folded and formed in a rectangular shape as shown in FIG. 21A and FIG. 21B. Its leading end straight portion 65a is a linear leading end pressing part for pressing the mark transfer tape on the transfer area 50.

The other structure and operation are same as in embodiment 1.

Embodiment 14

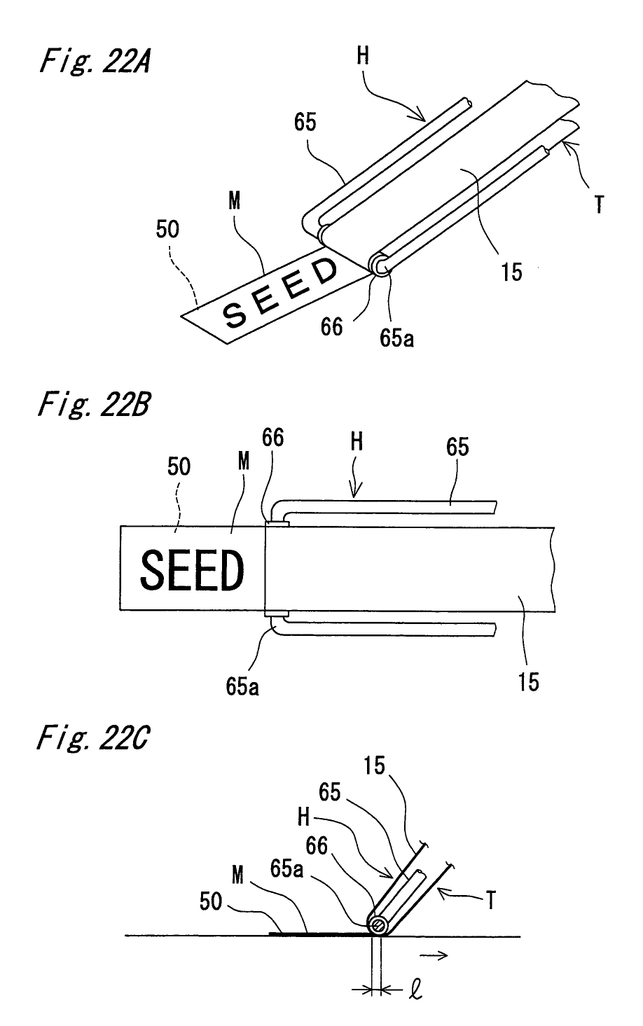

This embodiment is shown in FIG. 22A to FIG. 22C, and is similar to embodiment 13, except the structure of transfer head H is slightly modified.

That is, the transfer head H of this embodiment is similar to a wire head of embodiment 13, except that a pressing cylindrical member 66 is provided on the straight leading end pressing part 65a. This pressing cylindrical member 66 is a slender cylindrical body made of metal or elastic material, and is fixed on or disposed rotatably on the leading end pressing part 65a.

The other structure and operation are same as in embodiment 13.

Embodiment 15

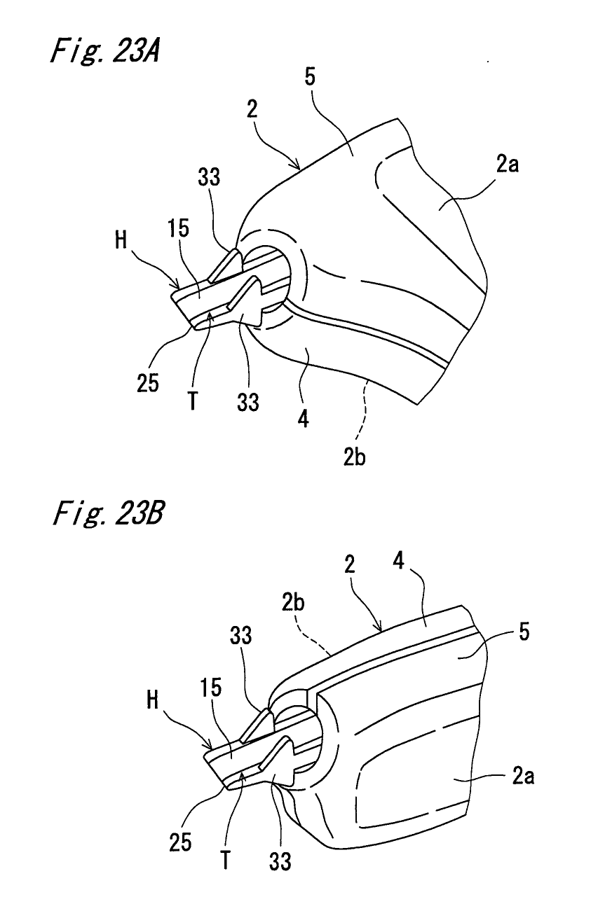

This embodiment is shown in FIG. 23A and FIG. 23B, and is similar to embodiment 1, except the structure of transfer head H is modified.

That is, the transfer head H of this embodiment is a fixed head not rotating about its axial line.

Specifically, as shown in the drawing, the transfer head H is formed integrally with the case main body 4 of the case 2 or cap body 5. A specific structure of the transfer head H is shown in FIG. 23A, in which the leading end pressing part 25 is at an angular position for pressing the mark transfer tape T in a state parallel to the gripping surfaces 2a, 2b of the case 2 as lateral pulling use type, or as shown ion FIG. 23B, in which the leading end pressing part 25a is at an angular position for pressing the mark transfer tape T in a state orthogonal to the gripping surfaces 2a, 2b of the case 2 as vertical pulling use type, so that either type may be used properly depending on the purpose.

The other structure and operation are same as in embodiment 1.

The invention is more specifically described below by referring to specific examples.

### EXAMPLE 1

Components in Table 1 and components in Table 2 were dispersed for 20 minutes by sand mills, and a paint for surface forming layer and a paint for mark array layer were prepared. As a paint for pressure-sensitive adhesive layer, 30% aqueous solution of ester acrylate was used.

Conforming to JIS K 6730, the rupture strength of the surface forming layer 17 prepared from this paint for surface forming layer was measured, and the result was 1.5 MPa, while the rupture strength of the mark array layer 18 was 0.5 MPa.

TABLE 1
(Surface forming layer 17)

| Component | Parts by weight |
|---|---|
| Toluene | 77.9 |
| Styrene-ethylene-butylene-styrene copolymer | 8.5 |
| Alicyclic saturated hydrocarbon | 5.7 |
| Inorganic filler | 6.4 |
| Dispersant | 1.5 |

TABLE 2
(Mark array layer 18)

| Component | Parts by weight |
|---|---|
| Toluene | 57.4 |
| Isopropylene alcohol (IPA) | 28.0 |
| Styrene-ethylene-butylene-styrene copolymer | 6.0 |
| Inorganic filler | 2.0 |
| Dispersant | 0.6 |
| Blue pigment | 6.0 |

On one side of both-side parting polyethylene film base tape 15, the paint for surface forming layer was applied in a dry film thickness of 15 μm by using a slit coater, and the paint for mark array layer was further applied thereon by using a gravure coater in a dry film thickness of 0.5 μm by printing a circular pattern of 4 mm in diameter at a pitch of 6 mm in width direction and 8 mm in flow direction, and a mark array layer 18 of dot pattern was formed. Further thereon, the paint for pressure-sensitive adhesive layer was applied in a dry film thickness of 1 μm.

The obtained mark transfer layer 16 was taken up on a core in a length of 10 m while slitting in a width of 6 mm, and a pancake-like mark transfer tape T of laminated structure as shown in FIG. 5A to FIG. 5C (embodiment 1) was obtained. It was installed in the mark transfer tool shown in FIG. 1 to FIG. 3, and transferred on a PPC paper by 200 mm under a load of about 5N, and the transfer mark M (pressure-sensitive adhesive mark 19+mark array layer 18+surface forming layer 17) was favorably transferred at an elongation rate of about 90%, without visual deformation, crack or cut.

### EXAMPLE 2

Using the same paint for surface forming layer, paint for mark array layer, and paint for pressure-sensitive adhesive layer as in example 1, a pancake-like mark transfer tape T of laminated structure as shown in FIG. 17A to FIG. 17C (embodiment 9) was prepared.

That is, on one side of both-side parting polyethylene film base tape 15 of 26 μm in thickness, the paint for mark array layer was applied in a dry film thickness of 0.5 μm by using a gravure coater by printing a circular pattern (mark) M of 4 mm in diameter at a pitch of 6 mm in width direction and 8 mm in flow direction, and a mark array layer 18 of dot patterns M, M, . . . was formed. On this mark array layer 18, the paint for surface forming layer was applied in a dry film thickness of 15 μm by using a slit coater, and further thereon, the paint for pressure-sensitive adhesive layer was applied in a dry film thickness of 1 μm.

The obtained mark transfer layer 16 was treated same as in example 1, and a pancake-like mark transfer tape T of laminated structure as shown in FIG. 17A to FIG. 17C (embodiment 9) was obtained. It was installed in the mark transfer tool shown in FIG. 1 to FIG. 3, and transferred on a PPC paper by 200 mm under a load of about 5N, and the transfer mark M (pressure-sensitive adhesive mark 19+mark array layer 18+surface forming layer 17) was favorably transferred at an elongation rate of about 90%, without visual deformation, crack or cut.

### COMPARATIVE EXAMPLE 1

A mark transfer tape T was obtained by the same operation as in example 1, except that the paint for mark array layer was prepared by dispersing components in Table 3 for 20 minutes by a sand mill. The rupture strength of the surface forming layer 17 was 1.5 MPa and the rupture strength of the mark array layer was 1.0 MPa.

TABLE 3
(Mark array layer 18)

| Component | Parts by weight |
|---|---|
| Toluene | 57.4 |
| Isopropylene alcohol (IPA) | 28.0 |
| Styrene-ethylene-butylene-styrene copolymer | 3.0 |
| Alicyclic saturated hydrocarbon | 2.0 |
| Dispersant | 0.6 |
| Blue pigment | 6.0 |

The obtained mark transfer layer 16 was installed in the mark transfer tool shown in FIG. 1 to FIG. 3, and transferred on a PPC paper by 200 mm under a load of about 5N, and three cracks of 2 mm or more in length were formed in the mark array layer 18 of the transfer mark M.

### COMPARATIVE EXAMPLE 2

A mark transfer tape T was obtained by the same operation as in example 1, except that the paint for surface forming layer was prepared by dispersing components in Table 4 for 20 minutes by a sand mill. The rupture strength of the surface forming layer 17 was 0.3 MPa and the rupture strength of the mark array layer was 0.5 MPa.

TABLE 4
(Surface forming layer 17)

| Component | Parts by weight |
|---|---|
| Toluene | 74.4 |
| Styrene-ethylene-butylene-styrene copolymer | 4.8 |
| Alicyclic saturated hydrocarbon | 11.2 |
| Inorganic filler | 8.0 |
| Dispersant | 1.6 |

The obtained mark transfer tape T was installed in the mark transfer tool shown in FIG. 1 to FIG. 3, and transferred on a PPC paper by 200 mm under a load of about SN, and scores of cracks of 2 mm or more in length were formed near the boundary of the mark array layer 18 of the surface forming layer 17 in the transfer mark M.

The foregoing embodiments 1 to 15 merely show preferred embodiments of the invention, and the invention is not limited to them alone, but may be modified in design freely within its scope.

For example, the specific structure of the mark transfer tool 1 may be realized by other structure. For instance, the transfer head H in the shown embodiments has a so-called rotary head structure having the head main body 30 rotatably held about its axial center, and it is designed to be used in various tape pressing transfer positions as shown in FIG. 8A to FIG. BC, but a so-called fixed head structure may be employed if only one of these tape pressing transfer positions is enough.

As described herein, the mark transfer tool of the invention comprises a hand-held case, a pay-out reel of mark transfer tape rotatably installed in the case, a winding reel for collecting the used mark transfer tape rotatably installed in the case, and a transfer head for pressing and transferring the mark transfer tape paid out from the pay-out reel onto the transfer area, being disposed in the leading end portion of the case, in which the mark transfer tape has a peelable transfer mark layer of multiple pressure-sensitive adhesive transfer marks adhesively held on the surface side of a base tape, and this transfer mark layer is formed by integrally laminating at least a pressure-sensitive adhesive layer of pressure-sensitive adhesive material, and a mark array layer of multiple marks consecutively arranged at specific intervals in the running direction of the base tape, and further the adhesive force PA of the pressure-sensitive adhesive layer on the transfer area, the rupture strength PB of the transfer mark layer, the adhesive force PC of the transfer mark layer and base tape, and the adhesive force PD of the pressure-sensitive adhesive layer and base tape are set in the relation of PA≧PB≧PC≧PD, and the elongation rate of the transfer mark layer is set in a visual deformation allowable range of the transfer mark at the time of pressing and transferring of the transfer mark layer by the transfer head, and therefore various transfer marks composed of characters, signs, symbols or combination thereof may be used by pressing like stamps, or by adhering like mark seals, and completely novel mark transfer techniques different from the conventional mark using techniques may be presented, and diversified preferences of general users can be effectively satisfied.

That is, to transfer the transfer mark on the mark transfer tape on a desired transfer area such as sheet of paper by the mark transfer tool of the invention, the case is gripped by the hand and fingers, and the leading end pressing part of the transfer head is tightly pressed against the transfer area, and the case is directly moved along the sheet of paper, so that the transfer mark is transferred. The mark transfer tape after use from which the transfer mark has been peeled, that is, the base tape is taken up and collected on the winding reel.

In this case, the adhesive force PA of the pressure-sensitive adhesive layer on the transfer area, the rupture strength PB of the transfer mark layer, the adhesive force PC of the transfer mark layer and base tape, and the adhesive force PD of the pressure-sensitive adhesive layer and base tape are set in the relation of PA≧PB≧PC≧PD, and the elongation rate of the transfer mark layer is set in a visual deformation allowable range of the transfer mark at the time of pressing and transferring of the transfer mark layer by the transfer head, and therefore a favorable cutting property at desired position of the transfer mark layer, that is, favorable transfer of desired transfer mark only is assured.

Further, since cutting lines are appropriately provided in the transfer mark layers, together with such favorable transfer property of transfer mark, the transfer mark can be cut off easily at a desired position.

In the case of the transfer mark composed of indication mark and overwriting space, moreover, after transfer of transfer mark, any desired letter can be overwritten by writing tool in the overwriting space.

In such overwriting space in the transfer mark, still more, it is possible to write in a material not to be written on directly by writing tool or in material not erased cleanly if once written on.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A mark transfer tool for transferring a transfer mark on a mark transfer tape onto a sheet of paper or the like, comprising:
a hand-held case to be handled by one hand,
a pay-out reel of mark transfer tape rotatably installed in the case,
a winding reel for collecting the used mark transfer tape rotatably installed in the case, and
a transfer head for pressing and transferring the mark transfer tape paid out from the pay-out reel onto the transfer area, being disposed in the leading end portion of the case,
wherein the mark transfer tape has a peelable transfer mark layer of multiple pressure-sensitive adhesive transfer marks adhesively held on the surface side of a base tape,
this transfer mark layer is formed by integrally laminating at least a pressure-sensitive adhesive layer of pressure-sensitive adhesive material, and a mark array layer of multiple marks consecutively arranged at specific intervals in the running direction of the base tape,
the adhesive force PA of the pressure-sensitive adhesive layer on the transfer area, the rupture strength PB of the transfer mark layer, the adhesive force PC of the transfer mark layer and base tape, and the adhesive force PD of the pressure-sensitive adhesive layer and base tape are set in the relation of PA≧PB≧PC≧PD, and
the elongation rate of the transfer mark layer is set in a visual deformation allowable range of the transfer mark at the time of pressing and transferring of the transfer mark layer by the transfer head.

2. The mark transfer tool of claim 1,
wherein at least two cutting lines are provided at a specified interval between transfer marks of the transfer mark layer, and
these cutting lines are linearly extended and formed in the overall width of the transfer mark layer.

3. The mark transfer tool of claim 1,
wherein multiple cutting lines are provided at a specified interval in the overall length of the transfer mark layer, in the transfer mark layer, and
these cutting lines are linearly extended and formed in the overall width of the transfer mark layer.

4. The mark transfer tool of claim 2 or 3, wherein the disposing interval of the cutting lines is set larger than the pressing width of the leading end pressing part of the transfer head.

5. The mark transfer tool of claim 1, wherein the transfer mark is composed of various indication marks only.

6. The mark transfer tool of claim 1, wherein the transfer mark is composed of various indication marks and overwriting spaces.

7. The mark transfer tool of claim 6, wherein at least the surface forming portion of the overwriting spaces in the transfer mark is made of a material for writing on by a writing tool.

8. The mark transfer tool of claim 6, wherein the overwriting space in the transfer mark is formed as a writing window penetrating through the face and back sides of the transfer mark.

9. The mark transfer tool of claim 1, wherein the transfer mark is an aromatic mark having an aromatic effect.

10. The mark transfer tool of claim 1, wherein the transfer mark is an antibacterial mark having an antibacterial effect.

11. The mark transfer tool of claim 1, wherein the transfer head is an elastic head elastically deformable in a pressing direction of the mark transfer tape.

12. The mark transfer tool of claim 11, wherein the transfer head is a pointed head having a linear leading end pressing part for pressing the mark transfer tape on the transfer area.

13. The mark transfer tool of claim 11, wherein the transfer head is a wire head having a linear leading end pressing part for pressing the mark transfer tape on the transfer area.

14. The mark transfer tool of claim 13, wherein a pressing cylindrical member is fitted to the linear leading end pressing part of the wire head.

15. The mark transfer tool of claim 1, wherein the transfer head is a rotary head capable of rotating about its axial line.

16. The mark transfer tool of claim 1, wherein the transfer head is a fixed head not rotating about its axial line.

17. The mark transfer tool of claim 16, wherein the transfer head is one of lateral pulling use type of which leading end pressing part is at an angular position for pressing the mark transfer tape in a state parallel to the gripping surface of the case.

18. The mark transfer tool of claim 16, wherein the transfer head is one of vertical pulling use type of which leading end pressing part is at an angular position for pressing the mark transfer tape in a state orthogonal to the gripping surface of the case.

19. The mark transfer tool of claim 1, wherein a tape cartridge comprising at least the pay-out reel and the winding reel is one of refill type detachably disposed in the case and incorporating an exchangeable mark transfer tape.

20. The mark transfer tool of claim 1, wherein the pay-out reel and the winding reel are installed in the case, and the transfer head is provided at the leading end of the case to form as a disposable type.

21. A mark transfer tape provided and used in a mark transfer tool for transferring a transfer mark on a sheet of paper or the like,
wherein a transfer mark layer of multiple pressure-sensitive adhesive transfer marks is peelably adhered and held on the surface side of a base tape,
the transfer mark layer is formed by integrally laminating at least a pressure-sensitive adhesive layer made of pressure-sensitive adhesive material, and a mark array layer made of multiple marks consecutively arranged at specific intervals in the running direction of the base tape,
the adhesive force PA of the pressure-sensitive adhesive layer on the transfer area, the rupture strength PB of the transfer mark layer, the adhesive force PC of the transfer mark layer and base tape, and the adhesive force PD of the pressure-sensitive adhesive layer and base tape are set in the relation of PA≧PB≧PC≧PD, and
the elongation rate of the transfer mark layer is set in a visual deformation allowable range of the transfer mark at the time of pressing and transferring of the transfer mark layer by the transfer head.

22. The mark transfer tape of claim 21,
wherein rubber-like resin and glass-like resin are contained as constituent materials for determining the elongation rate of the transfer mark layer, and
the elongation rate of this transfer mark layer is set at a specified value with in the visual deformational allowable range by adjusting the blending rates of the rubber-like and glass-like resins.

23. The mark transfer tape of claim 21,
wherein the transfer mark layer is formed by integrally laminating the pressure-sensitive adhesive layer of transparent material and the mark array layer, and
this transfer mark layer is peelably and separably adhered and held on a parting treated surface of the base tape by way of the pressure-sensitive adhesive layer.

24. The mark transfer tape of claim 21,
wherein the transfer mark layer is formed by integrally laminating the mark array layer and pressure-sensitive adhesive layer, and
this transfer mark layer is peelably and separably adhered and held on a parting treated surface of the base tape by way of the pressure-sensitive adhesive layer.

25. The mark transfer tape of claim 21,
wherein the transfer mark layer is formed by integrally laminating the mark array layer and pressure-sensitive adhesive layer, and
this transfer mark layer is peelably and separably adhered and held on an adhesive treated surface of the base tape by way of the mark array layer.

26. The mark transfer tape of claim 21,
wherein the transfer mark layer is formed by integrally laminating a pressure-sensitive adhesive layer of a pressure-sensitive adhesive transparent material, a mark array layer of multiple marks consecutively arranged at specified intervals in the running direction of a base tape, and a surface forming layer forming a surface portion, and
the mark array layer has its elongation rate set larger than the elongation rate of the surface forming layer, and its rupture strength set smaller than the rupture strength of the surface forming layer.

27. The mark transfer tape of claim 26,
wherein the transfer mark layer is formed by integrally laminating sequentially the surface forming layer of adhesive transparent material, mark array layer, and pressure-sensitive adhesive layer, and
this transfer mark layer is peelably and separably adhered and held on a parting treated surface of the base tape by way of the surface forming layer.

28. The mark transfer tape of claim 26,
wherein the transfer mark layer is formed by integrally laminating sequentially the surface forming layer of adhesive transparent material, pressure-sensitive adhesive layer of transparent material, and mark array layer, and
this transfer mark layer is peelably and separably adhered and held on a parting treated surface of the base tape by way of the surface forming layer.

29. The mark transfer tape of claim 26,
wherein the transfer mark layer is formed by integrally laminating sequentially the mark array layer, surface forming layer, and pressure-sensitive adhesive layer, and
this transfer mark layer is peelably and separably adhered and held on a parting treated surface of the base tape by way of the mark array layer.

30. The mark transfer tape of claim 21,
wherein at least two cutting lines are provided at a specified interval between transfer marks of the transfer mark layer, and
these cutting lines are linearly extended and formed in the overall width of the transfer mark layer.

31. The mark transfer tape of claim 21,
wherein multiple cutting lines are provided in the transfer mark layer at a specified interval in the overall length of the transfer mark layer, and
these cutting lines are linearly extended and formed in the overall width of the transfer mark layer.

32. The mark transfer tape of claim 30 or 31, wherein the disposing interval of the cutting lines is set larger than the pressing width of the leading end pressing portion of the transfer head for pressing and transferring the transfer head.

33. The mark transfer tape of claim 21, wherein the transfer mark is composed of various indication marks only.

34. The mark transfer tape of claim 21, wherein the transfer mark is composed of various indication marks and overwriting spaces.

35. The mark transfer tape of claim 34, wherein the surface forming portion of the overwriting spaces in the transfer mark is made of a material for writing on by a writing tool.

36. The mark transfer tape of claim 34, wherein the overwriting space in the transfer mark is formed as a writing window penetrating through the face and back sides of the transfer mark.

37. The mark transfer tape of claim 21, wherein the transfer mark contains an aromatic component to be presented as an aromatic mark having an aromatic effect.

38. The mark transfer tape of claim 21, wherein the transfer mark contains an antibacterial component to be presented as an antibacterial mark having an antibacterial effect.
